(19) United States
(12) Patent Application Publication
(10) Pub. No.: US 2006/0107859 A1
(43) Pub. Date: May 25, 2006

(54) Printing method employing processless printing plate material

(75) Inventor: Takeshi Sampei, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Medical & Graphic, Inc.

(21) Appl. No.: 11/284,211

(22) Filed: Nov. 21, 2005

(30) Foreign Application Priority Data
Nov. 25, 2004 (JP) JP2004-340249

(51) Int. Cl. B41N 1/00

(52) U.S. Cl. 101/453

(57) ABSTRACT

A printing process employing a processless printing plate material is disclosed, the process comprising the steps of (a) imagewise exposing a printing plate material comprising a support with a hydrophilic surface and an image formation layer provided on the hydrophilic surface, (b) mounting the exposed printing plate material on a plate cylinder of a printing press, (c) supplying a dampening solution and printing ink to the mounted printing plate material, whereby the image formation layer at non-image portions is removed to obtain a printing plate, and (d) further supplying the dampening solution and printing ink to the resulting printing plate, wherein the dampening solution contains water, a wetting property improving agent and a phosphorous compound in an amount of not more than 0.01 mol/liter, the dampening solution having a pH of from 4.5 to 8.0.

This application is based on Japanese Patent Application No. 2004-340249 filed on Nov. 25, 2004 in Japanese Patent Office, the entire content of which is hereby incorporated by reference.

### FIELD OF THE INVENTION

The present invention relates to a printing process employing a processless printing plate material providing high printing durability and excellent anti-stain property.

### BACKGROUND OF THE INVENTION

An inexpensive printing plate material for CTP (Computer to Plate) systems, which can be easily handled and has a printing capability comparable to that of PS plates, is required for digitization of printing data.

In recent years, a so-called processless printing plate material has been desired from the viewpoints of environmental protection, which does not require development employing specific chemicals. Thus, a printing process (see for example Japanese Patent O.P.I. Publication No. 4-261539) has been noticed which comprises the steps of mounting a printing plate material after image formation on a printing press without treating with any specific processing chemicals, and supplying a dampening solution and printing ink to the printing plate material to remove non-image portions and obtain a printing plate for printing.

A conventional printing process employing a processless printing plate material has problems which are insufficient in printing durability and in stain elimination property in which ink stain, when it occurs at non-image portions of a printing plate during printing, is eliminated by increasing a supply amount of a dampening solution. A printing process for solving the above problems has been sought.

### SUMMARY OF THE INVENTION

In view of the above, the present invention has been made. An object of the invention is to provide a printing process employing a processless printing plate material, which is improved in printing durability and anti-stain property.

### DETAILED DESCRIPTION OF THE INVENTION

The above problems can be attained by any one of the following constitutions:

1. A printing process employing a processless printing plate material, the process comprising the steps of (a) imagewise exposing a printing plate material comprising a support with a hydrophilic surface and an image formation layer provided on the hydrophilic surface, (b) mounting the exposed printing plate material on a plate cylinder of a printing press, (c) supplying a dampening solution and printing ink to the mounted printing plate material, whereby the image formation layer at non-image portions is removed to obtain a printing plate, and (d) further supplying the dampening solution and printing ink to the resulting printing plate, wherein the dampening solution contains water, a wetting property improving agent, and a phosphorous compound in an amount of not more than 0.01 mol/liter, the dampening solution having a pH of from 4.5 to 8.0.

2. The printing process of item 1 above, wherein the dampening solution contains no phosphorous compound.

3. The printing process of item 1 above, wherein the dampening solution contains water in an amount of 90 to 99.8% by weight, and the wetting property improving agent in an amount of from 0.001 to 1% by weight.

4. The printing process of item 1 above, wherein the image formation layer contains heat-melting particles or heat-fusible particles.

5. The printing process of item 4 above, wherein a content of the heat-melting particles or heat-fusible particles in the image formation layer is from 0.1 to 95% by weight.

6. The printing process of item 1 above, wherein the image formation layer has a thickness of from 0.1 to 10 μm.

7. The printing process of item 1 above, wherein the support has on the surface a hydrophilic layer with a porous structure.

8. The printing process of item 7 above, wherein the support comprises a plastic film and provided thereon, the hydrophilic layer.

9. The printing process of item 8 above, wherein the plastic film is a polyethylene terephthalate film.

10. The printing process of item 7 above, wherein the hydrophilic layer contains metal oxide particles with an average size of from 3 to 100 nm.

11. The printing process of item 10 above, wherein the metal oxide particle content of the hydrophilic layer is from 0.1 to 95% by weight.

12. The printing process of item 7 above, wherein the hydrophilic layer has a thickness of from 0.1 to 20 μm.

13. The printing process of item 1 above, wherein the image formation layer contains a light-to-heat conversion material.

14. The printing process of item 7 above, wherein the hydrophilic layer contains a light-to-heat conversion material.

15. The printing process of item 7 above, wherein both image formation layer and hydrophilic layer contain a light-to-heat conversion material.

16. The printing process of item 1 above, wherein a hydrophilic overcoat layer containing a water soluble resin or a water swellable resin is provided on the image formation layer.

1-1. A printing process employing a processless printing plate material, the process comprising the steps of imagewise exposing a printing plate material comprising a support with a hydrophilic surface and an image formation layer on the hydrophilic surface, mounting the exposed printing plate material on a plate cylinder of a printing press, supplying a dampening solution and printing ink to the mounted printing plate material to remove the image formation layer at non-image portions, whereby a printing plate is obtained, and further supplying the dampening solution and printing ink to the resulting printing plate, wherein the dampening solution has a pH of from 4.5 to 8, and contains a phosphorous compound in an amount of not more than 0.01 mol/liter.

1-2. The printing process of item 1-1 above, wherein the image formation layer contains heat-melting particles or heat-fusible particles.

1-3. The printing process of item 1-1 or 1-2 above, wherein the support with a hydrophilic surface has a hydrophilic layer with a porous structure on the surface.

1-4. The printing process of any one of items 1-1 through 1-3 above, wherein the printing plate material further comprises a layer containing a light-to-heat conversion material, which is provided on the surface of the support on the image formation layer side.

The preferred embodiment of the invention will be detailed below.

In the printing process according to the invention employing a processless printing plate material, a printing plate is prepared by exposing the image formation layer of the processless printing plate material to laser light according to the image information to form an image.

The exposure is a scanning exposure employing a semiconductor laser emitting infrared or near-infrared light, i.e., light with a wavelength of from 700 to 1500 nm. In the printing process of the invention employing a processless printing plate material, for example, the planographic printing plate material is provided along the outer peripheral wall of the drum of a printing press, and subjected to scanning exposure in the rotational direction (in the main scanning direction) of the drum, employing one or several lasers located outside the cylinder, while moving the lasers in the normal direction (in the sub-scanning direction) to the rotational direction of the drum to form an image.

The processless printing plate material, comprising an image formation layer on the hydrophilic surface of the hydrophilic support, has property that after image recording, printing can be carried out without a special development process. After the printing plate material is imagewise exposed and mounted on a plate cylinder of a printing press, or after the printing plate material is mounted on the cylinder and then imagewise exposed, a dampening solution supply roller and/or an ink supply roller are brought into contact with the surface of the resulting printing plate material while rotating the plate cylinder to remove an image formation layer at non-image portions and prepare a printing plate on the plate cylinder.

The non-image portion image formation layer removal on the plate cylinder after image exposing as described above is carried out in the same sequences as in conventional PS plates. This is so-called development on-press.

In the printing process of the invention employing a processless planographic printing plate material, the dampening solution, which is supplied to the printing plate material through the dampening solution supply roller, contains components described later.

In the invention, the dampening solution has a pH of from 4.5 to 8, and contains a phosphorous compound in an amount of not more than 0.01 mmol/liter. It is preferred that the dampening solution contains no phosphorous compound.

It is presumed that the dampening solution, having a pH falling within the above range and containing the phosphorous compound in the amount as described above, preferably containing no phosphorous compound, easily removes an image formation layer at non-image portions of the planographic printing plate material during on-press development, whereby the stain elimination property is improved and printing durability is greatly improved.

Examples of the phosphorous compound include phosphoric acid or its salt, an organophosphorous compound, phosphorous acid or its salt, phosphorous acid or its salt, condensed phosphoric acid or its salt, a phytic acid compound, and a phosphonic acid compound.

The phosphate is not specifically limited, as long as it is compounds capable of releasing a phosphate ion in the aqueous solution. Examples thereof include phosphoric acid, phosphoric acid ammonium salts (such as ammonium phosphate, ammonium hydrogen phosphate, or ammonium dihydrogen phosphate), phosphoric acid alkali metal salt (such as sodium phosphate, sodium hydrogen phosphate, sodium dihydrogen phosphate, potassium phosphate), phosphoric acid alkaline earth metal salt (such as zinc phosphate, calcium phosphate, or magnesium phosphate), iron phosphate, manganese phosphate, and phosphomolybdic acid.

Examples of the organophosphorous compound include phenylphosphonic acid, phenylphosphoric acid, naphthylphosphonic acid, naphthylphosphoric acid, glycerophosphonic acid, glycerophosphoric acid, phenylphosphinic acid, naphthylphosphinic acid, diphenylphosphinic acid, dimethylphosphinic acid, p-nitrophenylphosphinic acid, and p-methoxyphenylphosphinic acid.

The phosphite is not specifically limited, as long as it is compounds capable of releasing a phosphite ion in the aqueous solution. Examples thereof include phosphorous acid, ammonium phosphite, sodium phosphite, and potassium phosphite.

The hypophosphite is not specifically limited, as long as it is compounds capable of releasing a hypophosphite ion in the aqueous solution. Examples thereof include hypophosphorous acid, ammonium hypophosphite, sodium hypophosphite, and potassium hypophosphite.

The condensed phosphoric acid salt is not specifically limited, as long as it is compounds capable of releasing a condensed phosphoric acid ion in the aqueous solution. Examples thereof include condensed phosphoric acids such as polyphosphoric acid, pyrophosphoric acid, metaphosphoric acid and ultraphosphoric acid; and their ammonium, alkali metal or alkaline earth metal salts.

The phytic acid compound is not specifically limited, as long as it is a compound capable of releasing a phytic acid ion in the aqueous solution. Examples thereof include phytic acid, and its ammonium, alkali metal or alkaline earth metal salts.

The phosphonic acid compound is not specifically limited, as long as it is a compound capable of releasing a phosphonic acid ion in the aqueous solution. Examples thereof include phosphonic acids such as aminotri(methylenephosphonic acid), 1-hydroxyethylidene-1,1-diphosphonic acid, ethylenediaminetetra(methylenephosphonic acid) and diethylenetriaminepenta(methylenephosphonic acid), and their ammonium or alkali metal salts.

The invention is characterized in that the dampening solution contains the phosphorous compound in an amount of not more than 0.01 mol/liter.

[Dampening Solution]

The dampening solution employed in the invention preferably contains, in addition to a wetting property improving agent (b), at least one selected from a pH adjusting agent (a), a water-soluble polymer (c), a deodorant (d), an antiseptic (e), a chelating agent (f), a colorant (g), (h) an anti-rusting agent and an anti-foaming agent (i). Preferred are a pH adjusting agent (a), a water-soluble polymer (c), and a chelating agent (f). As the pH adjusting agent, at least one selected from water-soluble organic or inorganic acids and their salts can be used. These compounds are effective in adjusting pH of a dampening solution, giving a buffering effect to a dampening solution, appropriately etching a support of a printing plate, and preventing corrosion of the support. Preferred organic acids include citric acid, ascorbic acid, malic acid, tartaric acid, lactic acid, acetic acid, gluconic acid, hydroxyacetic acid, oxalic acid, malonic acid, levulinic acid, sulfanilic acid, and p-toluenesulfonic acid. Examples of the inorganic acids include nitric acid and sulfuric acid. Alkali metal, alkaline earth metal, ammonium or organic amine salts of the organic or inorganic acids can be suitably used. These organic or inorganic acids or their salts may be used singly or as an admixture of two or more kinds thereof.

The content of the pH adjusting agent in the dampening solution is suitably from 0.001 to 0.1% by weight, in preventing stain occurrence during printing and preventing rust of a printing press.

The invention is-characterized in that pH of the dampening solution is from 4.5 to 8.0. A dampening solution with a pH of less than 4.5 damages the surface of a printing plate, resulting in lowering of printing durability. While a dampening solution with too a high pH, i.e., a pH exceeding 8.0 also damages the surface of a printing plate, resulting in lowering of printing durability.

Surfactants or specific solvents can be used as the wetting property improving agent (b). Examples of an anionic surfactant of the surfactants include fatty acid salts, abietic acid salts, hydroxyalkanesulfonic acid salts, alkanesulfonic acid salts, dialkylsulfosuccinic acid salts, straight chain alkylbebzenesulfonic acid salts, branched alktlbebzenesulfonic acid salts, alkylnaphthalenesulfonic acid salts, alkylphenoxypolyoxyethylene propylsulfonic acid salts, polyoxyethylene alkylsulfophenyl ether, N-methyl-N-oleyltaurine sodium salts, N-alkylsulfosuccinic acid. monoamide disodium salts, petroleum sulfonic acid salts, sulfated castor oil, sulfated tallow oil, fatty acid alkyl ester sulfuric acid ester salts, alkyl sulfate salts, polyoxyethylene alkyl ether sulfuric acid ester salts, fatty acid monoglyceride sulfate ester salts, polyoxyethylene alkylphenyl ether sulfuric acid salts, polyoxyethylene styrylphenyl ether sulfuric acid salts, alkylphosphate ester salts, polyoxyethylene alkyl ether phosphoric acid ester salts, polyoxyethylene alkylphenyl ether phosphoric acid ester salts, partially saponified styrene anhydrous maleic acid copolymer, partially saponified olefin-anhydrous maleic acid copolymer, and naphthalenesulfonic acid salt-formaline condensates. Of the foregoing, dialkylsulfosuccinic acid salts, alkyl sulfate salts and alkylnaphthalenesulfonic acid salts are preferred.

Examples of a nonionic surfactant of the surfactants include polyoxyethylene alkyl ethers, polyoxyethylene alkylphenyl ethers, polyoxyethylene polystyrylphenyl ethers, polyoxyethylene polyoxypropylene alkyl ethers, glycerin fatty acid partial esters, sorbitan fatty acid partial esters, pentaerythritol fatty acid partial esters, propylene glycol monofatty acid esters, sugar fatty acid partial esters, polyoxyethylene sorbitan fatty acid partial esters, polyoxyethylene sorbitol fatty acid partial esters, polyethylene glycol fatty acid esters, polyglycerin fatty acid partial esters, polyoxyethylene-modified caster oils, polyoxyethylene glycerin fatty acid partial esters, fatty acid diethanolamides, N,N-bis-2-hydroxyalkylamines, polyoxyethylene alkylamine, triethanolamine fatty acid esters, polyoxyethylene-polyoxypropylene block polymers, and trialkylamineoxides. Besides the above, fluorine-contained surfactants or silicon-contained surfactants can be also used. The surfactant content of the dampening solution preferably not more than 1% by weight, and more preferably from 0.001 to 0.5% by weight in view of foaming. The surfactants may be used as an admixture of two or more kinds thereof.

Examples of the specific solvents as the wetting property improving agent include ethylene glycol monomethyl ether, diethylene glycol monomethyl ether, triethylene glycol monomethyl ether, tetraethylene glycol monomethyl ether, ethylene glycol monoethyl ether, diethylene glycol monoethyl ether, triethylene glycol monoethyl ether, tetraethylene glycol monoethyl ether, ethylene glycol monopropyl ether, diethylene glycol monopropyl ether, triethylene glycol monopropyl ether, tetraethylene glycol monopropyl ether, ethylene glycol monoisopropyl ether, diethylene glycol monoisopropyl ether, triethylene glycol monoisopropyl ether, tetraethylene glycol monoisopropyl ether, ethylene glycol monobutyl ether, diethylene glycol monobutyl ether, triethylene glycol monobutyl ether, tetraethylene glycol monobutyl ether, ethylene glycol monoisobutyl ether, diethylene glycol monoisobutyl ether, triethylene glycol monoisobutyl ether, tetraethylene glycol monoisobutyl ether, ethylene glycol monotert-butyl ether, diethylene glycol monotert-butyl ether, triethylene glycol monotert-butyl ether, tetraethylene glycol monotert-butyl ether, propylene glycol monomethyl ether, dipropylene glycol monomethyl ether, tripropylene glycol monomethyl ether, propylene glycol monoethyl ether, dipropylene glycol monoethyl ether, tripropylene glycol monoethyl ether, tetrapropylene glycol monoethyl ether, propylene glycol monopropyl ether, dipropylene glycol monopropyl ether, tripropylene glycol monopropyl ether, propylene glycol monoisopropyl ether, dipropylene glycol monoisopropyl ether, tripropylene glycol monoisopropyl ether, dipropylene glycol monobutyl ether, tripropylene glycol monobutyl ether, propylene glycol monoisobutyl ether, dipropylene glycol monoisobutyl ether, tripropylene glycol monoisobutyl ether, propylene glycol monotert-butyl ether, dipropylene glycol monotert-butyl ether, tripropylene glycol monotert-butyl ether, polypropylene glycols having a molecular weight of from 200 to 1000 or their monomethyl, monoethyl, monopropyl, monoisopropyl or monobutyl ether, propylene glycol, dipropylene glycol, tripropylene glycol, tetrapropylene glycol, pentapropylene glycol, ethylene glycol, diethylene glycol, triethylene glycol, butylene glycol, hexylene glycol, 2-ethyl-1,3-hexanediol, 3-methoxy-3-methyl-1-butanol, 1-butoxy-2-propanol, glycerin, diglycerin, polyglycerin, trimethylol propane, 2-pyrrolidones having an alkyl group having a carbon atom number of from 1 to 8 at the 1-position, 3,5-dimethyl-1-hexyne-3-ol, 2,4,7,9-tetramethyl-5-decyne-4,7-diol, propargyl alcohol (2-propyne-1-ol), 3-butyne-1-ol, 1-butyne-3-ol, 2-butyne-1,4-diol, 3,6-dimethyl-4-octyne-3,6-diol. Among these, ethylene glycol monotert-butyl ether, 3-methoxy-3-methyl-1-butanol and 1-butoxy-2-propanol are especially preferred. These solvents may be used singly or as an admixture of two or more kinds thereof. The content of these solvents in the dampening solution is preferably from 0.002 to 1% by weight, and more preferably from 0.005 to 0.5% by weight.

As the water soluble polymer (c), there are natural products or their modification products such as gum arabic, starch derivatives (for example, dextrin, enzymatic degradation dextrin, hydroxypropylated enzymatic degradation dextrin, carboxymethylated starch, phosphoric acid starch, or octenylsuccinic acid-modified starch), alginates and cellulose derivatives (for example, carboxymethylcellulose, carboxyethylcellulose, methylcellulose, or hydroxyethylcellulose); synthetic products such as polyethylene glycol or its copolymer, polyvinyl alcohol or its copolymer, polyacrylamide or its copolymer, polyacrylic acid or its copolymer, vinyl methyl ether-maleic anhydride copolymer and polystyrene sulfonic acid or its copolymer; and polyvinyl pyrrolidone. Among these, carboxymethylcellulose, and hydroxyethylcellulose are especially preferred. The water soluble polymer content of the dampening solution is preferably from 0.001 to 0.5% by weight, and more preferably from 0.005 to 0.2% by weight.

As the deodorant (d), there are esters ordinarily used as perfumes. Examples thereof include a compound represented by formula (I) below.
R₁—COOR₂ Formula (I)

In formula (I), R₁ represents an alkyl group having a carbon atom number of from 1 to 15, an alkenyl group, an aralkyl group, or a phenyl group. The alkyl or alkenyl group has preferably a carbon atom number of from 4 to 8. The alkyl, alkenyl or aralkyl group of R₁ may be straight-chained or branched. The alkenyl group preferably has one double bond. Examples of the aralkyl group include a benzyl group and phenylethyl group. One or more hydrogen atoms of the alkyl, alkenyl, aralkyl or phenyl group may be substituted with a hydroxyl group or an acetyl group. R₂ represents an alkyl group having a carbon atom number of from 3 to 10, an aralkyl group, or a phenyl group, provided that the alkyl or aralkyl group may be straight-chained or branched. The alkyl group has preferably a carbon atom number of from 3 to 9. Examples of the aralkyl group of R₂ include a benzyl group and phenylethyl group.

Examples of the deodorant (d) include esters of formic acid, acetic acid, propionic acid, butyric acid, isobutyric acid, 2-ethylbutyric acid, valeric acid, isovaleric acid, 2-methylvaleric acid, hexanoic acid (caproic acid), 4-methylpentanoic (isohexanoic acid), 2-hexenoic acid, 4-pentenoic acid, heptanoic acid, 2-methylheptanoic acid, octanoic acid (caprylic acid), nonanoic acid, decanoic acid (capric acid), 2-decenoic acid, lauric acid, or myristic acid. In addition to the above, there are benzyl phenylacetate and acetoacetic acid esters such as ethyl acetoacetate or 2-hexyl acetoacetate. Among these, n-pentyl acetate, isopentyl acetate, n-butyl butyrate, n-pentyl butyrate and isopentyl butyrate are preferred, and n-butyl butyrate, n-pentyl butyrate and isopentyl butyrate are more preferred. The content of the deodorant (d) in the dampening solution is preferably from 0.001 to 0.5% by weight, and more preferably from 0.002 to 0.2% by weight. The deodorant can improve working environment. Vanillin or ethylvanillin can be used with the above deodorant.

As the antiseptic (e) used in the dampening solution invention, there are formalin, imidazole derivatives, sodium dehydroacetate, 4-isothiazoline-3-on derivatives, benzotriazole derivatives, amidine or guanidine derivatives, diazine or triazole derivatives, oxazole or oxazine derivatives, and bromonitroalcohols such as bromonitropropanol, 1,1-dibromo-1-nitro-2-ethaol and 3-bromo-3-nitropentane-2,4-diol. The content of the antiseptic. (e) in the dampening solution, although different due to kinds of bacteria, mildew or ferment, is an amount effective to the bacteria, mildew or ferment and is preferably from 0.001 to 0.5% by weight. Two or more kinds of the antiseptic effective to bacteria, mildew or ferment are preferably used in combination.

The dampening solution in the invention may contain a chelating agent (f). The dampening solution is ordinarily concentrated, and the concentrated dampening solution is diluted with tap water or well water on using. The calcium ion contained in tap water or well water for diluting has an adverse effect on printing, and may produce stain on printed matter. Addition of the chelating agent to the dampening solution overcomes the above problem. Preferred examples of the chelating agent include ethylenediaminetetracetic acid or its sodium or potassium salt; diethylenetriaminepentacetic acid or its sodium or potassium salt; hydroxyethylethylene-diaminetriacetic acid or its sodium or potassium salt; nitrilotriacetic acid or its sodium salt; organic phosphonic acids or their salts such as 1-hydroxyethane-1,1-diphosphonic acid or its sodium or potassium salt, and aminotri-(methylenephosphonic acid) or its sodium or potassium salt; and phosphonoalkane tricarboxylic acids or their salts. Organic amine salts of the acids mentioned above are also effective. Among these, those, which stably exist in a dampening solution and do not jeopardize printability, are employed. The chelating agent content of the dampening solution is preferably from 0.0001 to 0.5% by weight, and more preferably from 0.0005 to 0.2% by weight.

Colorants (g) used in the dampening solution in the invention are preferably dyes for food. Examples of yellow dyes include CI Nos. 19140, and 15985, examples of red dyes include CI Nos. 16185, 45430, 16255, 45380, and 45100, examples of violet dyes include CI No. 42640, examples of blue dyes include CI Nos. 42090 and 73015, and examples of green dyes include CI No. 42095. The colorant content of the dampening solution is preferably from 0.0001 to 0.5% by weight. Examples of anti-rusting agent (h) used in the dampening solution in the invention include benzotriazole, 5-methylbenzotriazole, thiosalicylic acid, benzimidazole or their derivative. The anti-foaming agent (i) used in the dampening solution in the invention is preferably a silicon-containing anti-foaming agent, which may be of the emulsion type or of the solution type. The anti-rusting agent content of the dampening solution is preferably from 0.0001 to 0.5% by weight.

The dampening solution in the invention can contain alcohols in order to adjust the surface tension or viscosity and improve the printing performance. Examples of the alcohols include methyl alcohol, ethyl alcohol, propyl alcohol, and isopropyl alcohol.

A constituent other that the components described above of the dampening solution in the invention is water. The dampening solution in the invention contains water in an amount of preferably from 90 to 99.8% by weight, and more preferably from 93 to 99.5% by weight. The dampening solution on the market is ordinarily a concentrated dampening solution. The concentrated dampening solution, which is comprised of the components described above, is prepared by dissolving the above solid components in water, preferably de-ionized water or pure water. The concentrated dampening solution is diluted with tap water or well-water by a factor of 10 to 200 on using.

The dampening solution in the invention can be used both in a conventional dampener and in a continuous feed dampening system, and is used preferably in the continuous feed dampening system. The dampening solution in the invention is applied to Mitsubishi Diamatic Dampener, Komorimatic Dampener, Dahlgren Dampener, or Alcolor Dampener manufactured by Heiderberg Co., Ltd.

[Ink]

Ink in the invention used in printing may be any ink used in planographic printing. As the ink, there are oily ink comprised of constituents such as a rosin-modified phenol resin, vegetable oil (linseed oil, tung oil, soybean oil, etc.), petroleum solvents, pigment and an oxidative polymerization catalyst (cobalt, manganese, lead, iron, zinc, etc.); UV-curable UV ink comprised of constituent such as acryl oligomers, acryl monomers, a photopolymerization initiator and pigment; and hybrid ink having both properties of oily ink and those of UV ink.

[Explanation of Printing Plate Material]

The printing plate material in the invention comprises a support, a component layer including a hydrophilic layer or an image formation layer provided on one surface of the support, and a backing layer optionally provided on the other surface of the support.

The printing plate material in the invention will be explained below.

(Support)

As a support capable of carrying the image formation layer of the printing plate material, materials used as supports for printing plates can be used. Examples of such a support include a metal plate, a plastic film, a paper sheet treated with polyolefin, and composite sheets such as laminates thereof. The thickness of the support is not specifically limited as long as a printing plate having the support can be mounted on a printing press, and is advantageously from 50 to 500 μm in easily handling.

Examples of the metal plate include iron, stainless steel, and aluminum. Aluminum or aluminum alloy (hereinafter also referred to as aluminum) is especially preferable in its gravity and stiffness. Aluminum is ordinarily used after degreased with an alkali, an acid or a solvent to remove oil on the surface, which has been used when rolled and wound around a spool. Degreasing is preferably carried out employing an aqueous alkali solution. The support is preferably subjected to adhesion enhancing treatment or subbing layer coating in order to enhance adhesion of the support to a layer to be coated. There is, for example, a method in which the support is immersed in, or coated with, a solution containing silicate or a coupling agent, and then dried. Anodization treatment is considered to be one kind of the adhesion enhancing treatment and can be employed as such. Further, a combination of the anodization treatment with the immersion or coating as above can be employed

An aluminum plate to have been surface roughened according to a conventional method, or an aluminum plate to have been surface roughened and then subjected to adhesion enhancing treatment can be employed. An aluminum plate to have been subjected to anodization treatment by a conventional method and optionally to surface treatment, a so-called grained aluminum plate, can be also employed.

Examples of the plastic film include a polyester film such as a polyethylene terephthalate film or a polyethylene naphthalate film, a polyimide film, a polyamide film, a polycarbonate film, a polysulfone film, a polyphenylene oxide film, and a cellulose ester film. The plastic film is preferably a polyester film, and more preferably a polyethylene terephthalate film or a polyethylene naphthalate film. A support having a rate of dimensional change of from 0.001 to 0.04% at 120° C. for 30 seconds is preferably used which is obtained according to a method disclosed in Japanese Patent O.P.I. Publication No. 10-10676.

The polyester film is preferably an unstretched polyester film, uniaxially stretched polyester film or biaxially stretched polyester film. Among these, a polyester film biaxially stretched in the longitudinal direction (mechanical direction) is especially preferred.

When an aqueous coating solution is coated on the polyester film, a conventional coating method, where a coating process in which the aqueous solution is coated on a polyester film after biaxially stretched and heat-fixed is carried out separated from the film manufacturing process, has a tendency to catch dirt or dust, which is undesired. In view of the above, the coating process is preferably carried out under clean circumstances, i.e., the clean circumstances under which the film manufacturing process is carried out. This coating process greatly improves adhesion of a coating (for example, a subbing layer described later) to the polyester film.

As the coating method, any known coating methods can be employed. Examples of the coating method include a roller coating method, a gravure coating method, a roll brush method, a spray coating method, an air knife coating method, an impregnating method, and a curtain coating method. These methods can be used singly or in combination. The coating amount of the aqueous solution is preferably from 0.5 to 20 g per m² of transporting film, and more preferably from 1 to 10 g per m² of transporting film. The aqueous solution is preferably an aqueous dispersion solution or an emulsion.

The stretchable polyester film, after coated with the aqueous solution, was subjected to drying treatment and then to stretching treatment. These treatments can be carried out according to conventional methods known in the art. The drying treatment is preferably carried out at 90 to 130° C. for 2 to 10 seconds. It is preferred that the dried film is stretched at 90 to 130° C. at a stretching magnification in the longitudinal direction of from 3 to 5 and at a stretching magnification in the transverse direction of from 3 to 5, optionally followed by re-stretching of a stretching magnification in the longitudinal direction of from 1 to 3. When the stretched film is heat-fixed, the heat fixing is carried out at from 180 to 240° C. for 2 to 20 seconds.

The thickness of a polyester film obtained after treated as above is preferably from 100 to 300 μm as the support.

The polyester of the polyester film for the support is not specifically limited, and contains, as a main component, a dicarboxylic acid unit and a diol unit. There are, for example, polyethylene terephthalate (hereinafter also referred to as PET), and polyethylene naphthalate (hereinafter also referred to as PEN).

The polyester is preferably PET, a copolyester comprising a PET component as a main component in an amount of not less than 50% by weight, or a polymer blend comprising PET in an amount of not less than 50% by weight.

PET is a polycondensate of terephthalic acid and ethylene glycol, and PEN is a polycondensate of naphthalene dicarboxylic acid and ethylene glycol. The polyester may be a polycondensate of the dicarboxylic acid and diol, constituting PET or PEN, and one or more kinds of a third component. As the third component, there is a compound having a divalent ester-forming functional group capable of forming an ester.

As the dicarboxylic acid, there is, for example, terephthalic acid, isophthalic acid, phthalic acid, 2,6-naphthalene dicarboxylic acid, 2,7-naphthalene dicarboxylic acid, diphenylsulfone dicarboxylic acid, diphenylether dicarboxylic acid, diphenylthioether dicarboxylic acid, diphenylketone dicarboxylic acid, diphenylindane dicarboxylic acid, and as a diol, there is, for example, propylene glycol, tetramethylene glycol, cyclohexanedimethanol, 2,2-bis(4-hydroxyphenyl)propane, 2,2-bis(4-hydroxyethoxyphenyl)propane, bis(4-hydroxyphenyl)-sulfone, bisphenolfluorene dihydroxyethyl ether, diethylene glycol, hydroquinone, cyclohexane diol. The third component may be a polycarboxylic acid or a polyol, but the content of the polycarboxylic acid or polyol is preferably from 0.001 to 5% by weight based on the weight of polyester.

The intrinsic viscosity of the polyester in the invention is preferably from 0.5 to 0.8. Polyesters having different viscosity may be used as a mixture of two or more kinds thereof.

A manufacturing method of the polyester in the invention is not specifically limited, and the polyester can be manufactured according to a conventional polycondensation method. As the manufacturing method, there is a direct esterification method in which a dicarboxylic acid is directly reacted with a diol by heat application to be esterified while distilling off the extra diol at elevated temperature under reduced pressure, or an ester exchange method

As catalysts, an ester exchange catalyst ordinarily used in synthesis of polyesters, a polymerization catalyst or a heat-resistant stabilizer can be used. Examples of the ester exchange catalyst include Ca(OAc)₂.H₂O, Zn(OAc)₂.2H₂O, Mn(OAc)₂.4H₂O, and Mg(OAc)₂.4H₂O. Examples of the polymerization catalyst include Sb₂O₃ and GeO₂. Examples of the heat-resistant stabilizer include Phosphoric acid, phosphorous acid, PO(OH) (CH₃)₃, PO(OH) (OC₆H₅)₃, and P(OC₆H₅)₃. During synthesis of polyesters, an anti-stain agent, a crystal nucleus agent, a slipping agent, an anti-blocking agent, a UV absorber, a viscosity adjusting agent, a transparentizing agent, an anti-static agent, a pH adjusting agent, a dye or pigment may be added.

(Heat Treatment of Support)

In the invention, the polyester film sheet after stretched and heat-fixed is preferably subjected to heat treatment in order to stabilize dimension of a printing plate and minimize “out of color registration” during printing. After the sheet has been stretched, heat fixed, cooled, wound around a spool once, and unwound, the sheet is properly heat treated at a separate process as follows.

As the heat treatment methods in the invention, there are a transporting method in which the film sheet is transported while holding the both ends of the sheet with a pin or a clip, a transporting method in which the film sheet is roller transported employing plural transporting rollers, an air transporting method in which the sheet is transported while lifting the sheet by blowing air to the sheet (heated air is blown to one or both sides of the sheet from plural nozzles), a heating method which the sheet is heated by radiation heat from for example, an infrared heater, a heating method in which the sheet is brought into contact with plural heated rollers to heat the sheet, a transporting method in which the sheet hanging down by its own weight is wound around an up-take roller, and a combination thereof.

Tension at heat treatment can be adjusted by controlling torque of an up-take roll and/or a feed-out roll and/or by controlling load applied to the dancer roller provided in the process. When the tension is changed during or after the heat treatment, an intended tension can be obtained by controlling load applied to the dancer roller provided in the step before, during and/or after the heat treatment. When the transporting tension is changed while vibrating the sheet, it is useful to reduce the distance the heated rollers.

In order to reduce dimensional change on heat processing (thermal development), which is carried out later, without inhibiting thermal contraction, it is desirable to lower the transporting tension as much as possible, and lengthen the heat treatment time. The heat treatment temperature is preferably in the range of from Tg+50° C. to Tg+150° C. In this temperature range, the transporting tension is preferably from 5 Pa to 1 MPa, more preferably from 5 Pa to 500 kPa, and most preferably from 5 Pa to 200 kPa, and the heat treatment time is preferably from 30 seconds to 30 minutes, and more preferably from 30 seconds to 15 minutes. The above described temperature range, transporting tension range and heat treatment time range can prevent the support planarity from lowering due to partial thermal contraction difference of the support occurring during heat treatment and prevent scrapes from occurring on the support due to friction between the support and transporting rollers.

In the invention, it is preferred that the heat treatment is carried out at least once, in order to obtain an intended dimensional variation rate. The heat treatment can be optionally carried out two or more times. In the invention, the heat-treated polyester film sheet is cooled from a temperature of around Tg to room temperature and wound around a spool. During cooling to room temperature from a temperature exceeding Tg, the heat-treated polyester film sheet is preferably cooled at a rate of not less than 5° C./second in order to prevent lowering of flatness of the sheet due to cooling. In the invention, the heat treatment is preferably carried out after a subbing layer described later and/or the adhesion layer has been coated.

(Water Content of Support)

In the invention, in order to secure good transportability in an exposure device or in a developing machine, the water content of the polyester film (hereinafter also referred to as polyester film support or polyester support) for the support is preferably not more than 0.5 by weight.

The water content of the support in the invention is D′ represented by the following formula:
D′ (weight %)=(w′/W′)×100
wherein W′ represents the weight of the support in the equilibrium state at 25° C. and 60% RH, and w′ represents the weight of water contained in the support in the equilibrium state at 25° C. and 60% RH.

The water content of the support is preferably not more than 0.5% by weight, more preferably from 0.01 to 0.5% by weight, and most preferably from 0.01 to 0.3% by weight.

As a method of obtaining a support having a water content of not more than 0.5% by weight, there is (1) a method in which the support is heat treated at not less than 100° C. immediately before an image formation layer or another layer is coated on the support, (2) a method in which an image formation layer or another layer is coated on the support under well-controlled relative humidity, and (3) a method in which the support is heat treated at not less than 100° C. immediately before an image formation layer or another layer is coated on the support, covered with a moisture shielding sheet, and then uncovered. Two or more of these methods may be used in combination.

(Particles)

Particles having a size of from 0.01 to 10 μm are preferably incorporated in an amount of from 1 to 1000 ppm into the polyester support, in improving handling property.

Herein, the particles may be organic or inorganic material. Examples of the inorganic material include silica described in Swiss Patent 330158, glass powder described in French Patent 296995, and carbonate salts of alkaline earth metals, cadmium or zinc described in British Patent 1173181. Examples of the organic material include starch described in U.S. Pat. No. 2,322,037, starch derivatives described such as in Belgian Patent 625451 and British Patent 981198, polyvinyl alcohol described in JP-B 44-3643, polystyrene or polymethacrylate described in Swiss Patent 330158, polyacrylonitrile described in U.S. Patent 3079257 and polycarbonate described in U.S. Pat. No. 3,022,169. The shape of the particles may be in a regular form or irregular form.

(Coating of Subbing Layer on the Support)

In order to give various functions to the polyester film support, the support can be coated with a subbing layer or can be subjected to adhesion increasing treatment. Examples of the adhesion increasing treatment include corona discharge treatment, flame treatment, plasma treatment and UV light irradiation treatment.

The subbing layer is preferably, more preferably a layer containing gelatin or latex. A conductive layer containing a conductive polymer disclosed in Japanese Patent O.P.I. Publication No. 7-20596, items [0031]-[0073] or a conductive layer containing a metal oxide disclosed in Japanese Patent O.P.I. Publication No. 7-20596, items [0074]-[0081] is preferably provided on the support. The conductive layer may be provided on one side or on both sides of the polyester film sheet support. It is preferred that the conductive layer be provided on the image formation layer side of the support. The conductive layer restrains electrostatic charging, reduces dust deposition on the support, and greatly reduces white spot faults at image portions during printing.

The support in the invention is preferably a polyester film sheet, but may be a composite support in which a plate of a metal (for example, iron, stainless steel or aluminum) or a polyethylene-laminated paper sheet is laminated onto a polyester film sheet. The composite support may be one in which the lamination is carried out before any layer is coated on the support, one in which the lamination is carried out after any layer has been coated on the support, or one in which the lamination is carried out immediately before mounted on a printing press.

(Image Formation Layer)

The image formation layer is a layer capable of forming an image to be printed after imagewise exposed. The image formation layer is preferably one used in an ablation type printing plate material forming an image employing a thermal laser or a thermal head as disclosed in JP-8-507727 or Japanese Patent O.P.I. Publication No. 6-186750, or one used in a heat-fusible image formation printing plate material of on-press development type or a heat-fusible transfer type printing plate material as disclosed in Japanese Patent O.P.I. Publication No. 9-123387.

Among these, an image formation layer used in an ablation type printing plate material, a heat-fusible image formation printing plate material of on-press development type, a heat-fusible transfer type printing plate material, or a phase-conversion type printing plate material, each being a processless CTP printing plate material, is preferred since load to environment is reduced.

It is preferred in the invention that the image formation layer contains heat-melting particles and/or heat-fusible particles. It is preferred in the invention that the image formation layer further contains a water-soluble binder.

(Heat-Melting Particles)

The heat-melting particles used in the invention are particularly particles having a low melt viscosity, or particles formed from materials generally classified into wax.

The materials preferably have a softening point of from 40° C. to 120° C. and a melting point of from 60° C. to 150° C., and more preferably a softening point of from 40° C. to 100° C. and a melting point of from 60° C. to 120° C.

Materials usable include paraffin, polyolefin, polyethylene wax, microcrystalline wax, and fatty acid wax. The molecular weight thereof is approximately from 800 to 10,000. A polar group such as a hydroxyl group, an ester group, a carboxyl group, an aldehyde group and a peroxide group may be introduced into the wax by oxidation to increase the emulsification ability. Moreover, stearoamide, linolenamide, laurylamide, myristylamide, hardened cattle fatty acid amide, parmitylamide, oleylamide, rice bran oil fatty acid amide, palm oil fatty acid amide, a methylol compound of the above-mentioned amide compounds, methylenebissteastearoamide and ethylenebissteastearoamide may be added to the wax to lower the softening point or to raise the working efficiency. A cumarone-indene resin, a rosin-modified phenol resin, a terpene-modified phenol resin, a xylene resin, a ketone resin, an acryl resin, an ionomer and a copolymer of these resins may also be usable.

Among them, polyethylene, microcrystalline wax, fatty acid ester and fatty acid are preferably contained. A high sensitive image formation can be performed since these materials each have a relative low melting point and a low melt viscosity. These materials each have a lubrication ability. Accordingly, even when a shearing force is applied to the surface layer of the printing plate precursor, the layer damage is minimized, and resistance to contaminations which may be caused by scratch is further enhanced.

It is preferred in the invention that the image formation layer contains two or more kinds of the heat-melting particles in order to provide both printability and visualization after exposure, a property to distinguish image portions from non-image portions after imagewise exposure. Herein, the two or more kinds of the heat-melting particles are different in their structure and/or their average particle size.

The heat-melting particles are preferably dispersible in water. The average particle size thereof is preferably from 0.01 to 10 μm, and more preferably from 0.05 to 3 μm.

When two or more kinds of the particles are used, the average particle size difference between the different particles is preferably not less than 0.1 μm.

A nonionic surfactant, an anionic surfactant, a cationic surfactant, or a polymeric surfactant is preferably employed to disperse these heat-melting particles in water. A heat-melting particle aqueous dispersion, containing these surfactants, can be stabilized, providing a uniform coat with no deficiencies.

Preferred examples of the nonionic surfactant include polyoxyethylene adducts such as alkyl polyoxyethylene ether, alkyl polyoxyethylene, polyoxypropylene ether, fatty acid polyoxyethylene ester, fatty acid polyoxyethylene sorbitan ester, fatty acid polyoxyethylene sorbitol ester, polyoxyethylene castor oil, polyoxyethylene adduct of acetylene glycol, and alkyl polyoxyethylene amine or amide; polyols such as fatty acid sorbitan ester, fatty acid polyglycerin ester and fatty acid sucrose ester or alkylolamide; silicon atom-containing surfactants, which are polyether modified, alkyl aralkyl polyether modified, epoxy polyether modified, alcohol modified, fluorine modified, amino modified, mercapto modified, epoxy modified, or allyl modified; fluorine atom-containing surfactants of perfluoroalkyl ethyleneoxide adduct; and others such as lipid-containing material, biosurfactant, or oligo soap. At least one kind of these can be used.

Preferred examples of the cationic surfactant include alkylamine salts or acylamine salts such as primary amine salts, acylaminoethylamine salts, N-alkylpolyalkylene polyamine salts, fatty acid polyethylene polyamide, amides or their salts, or amine salts; quaternary ammonium salts or ammonium salts having an amide bond such as alkyltrimethylammonium salt, dialkyldimethylammonium salt, alkyldimethylbenzyl ammonium salt, alkylpridium salt, acylaminoethylmethyldiethyl ammonium salt, acylaminopropyldimethylbenzyl ammonium salt, acylaminopropyldiethylhydroxyethyl ammonium salt, acylaminoethyl pyridinium salt, or diacylaminoethyl ammonium salt; ammonium salts having an ester bond or an ether bond such as diacyloxyethylmethylhydroxyethyl ammonium salt or alkyloxymethyl pyridinium salt; imidazolines or imidazolium salts such as alkyl imidazoline, 1-hydroxyethyl-2-alkyl imidazoline, or 1-acylaminoethyl-2-alkylimidazolium salt; amine derivatives such as alkylpolyoxyethylene amine, N-alkylaminopropyl amine, N-acylpolyethylene polyamine, acylpolyethylene polyamine, or fatty acid triethanolamine ester; and others such as lipid-containing material, biosurfactant or oligo soap. At least one kind of these can be used.

Preferred examples of the anionic surfactant include carboxylic acid salts such as fatty acid salt, rosin group, naphthene group, ether carboxylate, alkenyl succinate, N-acyl sarcosine salt, N-acyl glutamate, sulfuric acid primary alkyl salt, sulfuric acid secondary alkyl salt, sulfuric acid alkyl polyoxyethylene salt, sulfuric acid alkylphenyl polyoxyethylene salt, sulfuric acid mono-acyl glycerin salt, acyl amino sulfuric acid ester salt, sulfuric acid oil, or sulfation aliphatic acid alkyl ester; sulfonic acid such as α-olefin sulfonate, secondary alkane sulfonate, α-sulfo aliphatic acid, acyl isethionic acid salt, N-acyl-N-methyl taurine acid, dialkyl sulfo succinate, alkylbenzenesulfonate, alkylnaphthalenesulfonate, alkyl diphenyl ether disulfonate, petroleum sulfonate, or lignin sulfonate; phosphoric ester acid salt such as phosphoric acid alkyl salt or phosphoric acid alkyl polyoxyethylene salt; silicon atom-containing anionic surfactant such as sulfonic acid modified or carboxyl modified; fluorine atom-containing surfactant such as perfluoro alkyl carboxylic acid salt, perfluoro alkyl sulfonic acid salt, perfluoro alkyl phosphoric acid ester, or perfluoro alkyl trimethyl ammonium salt; and others such as lipid-containing material, biosurfactant, or oligo soap. At least one kind of these can be used.

Preferred examples of the polymeric surfactant include polymer or copolymer of poly alkyl(meth)acrylic acid such as poly(meth)acrylate, butyl(meth)acrylate acrylic acid, copolymer, ethylene-acrylic acid copolymer, or ethylene-methacrylic acid copolymer; maleic acid copolymer such as vinyl acetate-maleic anhydride copolymer, styrene-maleic anhydride copolymer, α-olefin-maleic anhydride copolymer, or diisobutylene-maleic acid copolymer; fumaric acid copolymer such as methyl(meth)acrylate-fumaric acid copolymer or vinyl acetate-fumaric acid copolymer; aromatic sulfonic-acid formalin condensation product such as naphthalene sulfonic acid formalin condensation product, butyl naphthalene sulfonic acid formalin condensation product, or cresol sulfonic-acid formalin condensation product; poly alkyl pyridinium salt (including derivatives of the copolymer obtained via copolymerization with vinyl monomer copolymerized with vinylpyridine) such as poly N-methylvinyl pyridinium chloride, or so forth; polyacrylamide, polyvinyl pyrrolidone, poly acryloyl pyrrolidone, polyvinyl alcohol, polyethylene glycol; block polymer of polyoxyethylene and polyoxypropylene; cellulose derivative such as methylcellulose or carboxymethyl cellulose; and polysaccharide derivative such as poly oxyalkylene polysiloxane copolymer, gum arabic, or arabinogalactan. At least one kind of these can be used. As for the above polymeric surfactant examples, alkali salt such as sodium, potassium, or ammonium may be allowed to be used in place of a polymeric surfactant containing a carboxyl group or a sulfone group.

The composition of the heat-melting particles may be continuously varied from the interior to the surface of the particles. The particles may be covered with a different material. Known microcapsule production method or sol-gel method can be applied for covering the particles. The heat-melting particle content of the layer is preferably 1 to 90% by weight, and more preferably 5 to 80% by weight based on the total layer weight.

(Heat-Fusible Particles)

The heat-fusible particles in the invention include thermoplastic hydrophobic polymer particles. Although there is no specific limitation to the upper limit of the softening point of the thermoplastic hydrophobic polymer particles, the softening point is preferably lower than the decomposition temperature of the polymer particles. The weight average molecular weight (Mw) of the polymer is preferably within the range of from 10,000 to 1,000,000.

Examples of the polymer consistituting the polymer particles include a diene (co)polymer such as polypropylene, polybutadiene, polyisoprene or an ethylene-butadiene copolymer; a synthetic rubber such as a styrene-butadiene copolymer, a methyl methacrylate-butadiene copolymer or an acrylonitrile-butadiene copolymer; a (meth)acrylate (co)polymer or a (meth)acrylic acid (co)polymer such as polymethyl methacrylate, a methyl methacrylate-(2-ethylhexyl)acrylate copolymer, a methyl methacrylate-methacrylic acid copolymer, or a methyl acrylate-(N-methylolacrylamide); polyacrylonitrile; a vinyl ester (co)polymer such as a polyvinyl acetate, a vinyl acetate-vinyl propionate copolymer and a vinyl acetate-ethylene copolymer, or a vinyl acetate-2-hexylethyl acrylate copolymer; and polyvinyl chloride, polyvinylidene chloride, polystyrene and a copolymer thereof. Among them, the (meth)acrylate polymer, the (meth)acrylic acid (co)polymer, the vinyl ester (co)polymer, the polystyrene and the synthetic rubbers are preferably used.

The polymer particles may be prepared from a polymer synthesized by any known method such as an emulsion polymerization method, a suspension polymerization method, a solution polymerization method and a gas phase polymerization method. The particles of the polymer synthesized by the solution polymerization method or the gas phase polymerization method can be produced by a method in which an organic solution of the polymer is sprayed into an inactive gas and dried, and a method in which the polymer is dissolved in a water-immiscible solvent, then the resulting solution is dispersed in water or an aqueous medium and the solvent is removed by distillation. In both of the methods, a surfactant such as sodium lauryl sulfate, sodium dodecylbenzenesulfate or polyethylene glycol, or a water-soluble resin such as poly(vinyl alcohol) may be optionally used as a dispersing agent or stabilizing agent.

The heat-fusible particles are preferably dispersible in water. The average particle size of the heat-fusible particles is preferably from 0.01 to 10 μm, and more preferably from 0.1 to 3 μm.

Further, the composition of the heat-fusible particles may be continuously varied from the interior to the surface of the particles. The particles may be covered with a different material. As a covering method, known methods such as a microcapsule method and a sol-gel method are usable. The heat-fusible particle content of the layer is preferably from 1 to 90% by weight, and more preferably from 5 to 80% by weight based on the total weight of the layer.

The image formation layer has a thickness of preferably from 0.1 to 10 μm, and more preferably from 0.2 to 5 μm.

(Water-Soluble Binder)

Examples of the water-soluble binder used in the image formation layer include polysaccharides, polyethylene oxide, polypropylene oxide, polyvinyl alcohol, polyethylene glycol (PEG), polyvinyl ether, latex of a conjugate diene polymer such as styrene-butadiene copolymer or methyl methacrylate-butadiene copolymer, acryl polymer latexes, vinyl polymer latexes, polyacrylamide, polyacrylic acid or its salt, and polyvinyl pyrrolidone. Of these, polyacrylic acid or its salt or polysaccharides are preferred, which do not lower printability.

In the invention, it is preferred that a coating solution for the image formation layer contain lower alcohols such as methanol, ethanol, isopropanol and butanol, in order to improve coating quality.

The image formation layer can contain light-to-heat conversion materials described later.

The dry coating amount of the image formation layer is preferably from 0.1 to 1.5 g/m², and more preferably from 0.15 to 1.0 g/m².

(Hydrophilic Layer)

It is preferred in the invention that the printing plate material comprises at least one hydrophilic layer between the support and the image formation layer. Next, the hydrophilic layer will be explained. The hydrophilic layer in the printing plate material refers to a layer constituting non-image portions and exhibiting high repellency to ink and high affinity to water in printing.

It is preferred in the invention that the hydrophilic layer provided on the support with a hydrophilic surface has a porous structure. In order to form the hydrophilic layer having such a porous structure, materials described later forming a hydrophilic matrix phase are used.

Material for forming the hydrophilic matrix phase is preferably a metal oxide.

(Metal Oxide)

The metal oxide preferably comprises metal oxide particles. Examples of the metal oxide particles include particles of colloidal silica, alumina sol, titania sol and another metal oxide sol. The metal oxide particles may have any shape such as spherical, needle-like, and feather-like shape. The average particle size of the metal oxide particles is preferably from 3 to 100 nm, and more preferably from 5 to 70 μm. Plural kinds of metal oxide each having a different size may be used in combination. The surface of the particles may be subjected to surface treatment.

The metal oxide particles can be used as a binder, utilizing its layer forming ability. The metal oxide particles are suitably used in the hydrophilic layer since they minimize lowering of the hydrophilicity of the layer as compared with an organic compound binder. The metal particle oxide content of the hydrophilic layer is preferably from 0.1 to 95% by weight, and more preferably from 1 to 90% by weight.

(Colloidal Silica)

Among the above-mentioned, colloidal silica is particularly preferred. The colloidal silica has a high layer forming ability under a drying condition with a relative low temperature, and can provide a good layer strength. It is preferred that the colloidal silica used in the invention is necklace-shaped colloidal silica or colloidal silica particles having an average particle size of not more than 20 nm, each being described later. Further, it is preferred that the colloidal silica provides an alkaline colloidal silica solution as a colloid solution.

The necklace-shaped colloidal silica to be used in the invention is a generic term of an aqueous dispersion system of a spherical silica having a primary particle size of the order of nm. The necklace-shaped colloidal silica to be used in the invention means a “pearl necklace-shaped” colloidal silica formed by connecting spherical colloidal silica particles each having a primary particle size of from 10 to 50 μm so as to attain a length of from 50 to 400 nm. The term of “pearl necklace-shaped” means that the image of connected colloidal silica particles is like to the shape of a pearl necklace.

Bonding between the silica particles forming the necklace-shaped colloidal silica is considered to be —Si—O—Si—, which is formed by dehydration of —SiOH groups located on the surface of the silica particles. Concrete examples of the necklace-shaped colloidal silica include Snowtex-PS series produced by Nissan Kagaku Kogyo, Co., Ltd. As the products, there are Snowtex-PS-S (the average particle size in the connected state is approximately 110 nm), Snowtex-PS-M (the average particle size in the connected state is approximately 120 nm) and Snowtex-PS-L (the average particle size in the connected state is approximately 170 nm). Acidic colloidal silica corresponding to each of the above-mentioned are Snowtex-PS-S-O, Snowtex-PS-M-O and Snowtex-PS-L-O, respectively.

The necklace-shaped colloidal silica is preferably used in a hydrophilic layer as a porosity providing material for hydrophilic matrix phase, and porosity and strength of the layer can be secured by its addition to the layer. Among them, the use of Snowtex-PS-S, Snowtex-PS-M or Snowtex-PS-L, each being alkaline colloidal silica particles, is particularly preferable since the strength of the hydrophilic layer is increased and occurrence of background contamination is inhibited even when a lot of prints are printed.

It is known that the binding force of the colloidal silica particles is become larger with decrease of the particle size. The average particle size of the colloidal silica particles to be used in the invention is preferably not more than 20 nm, and more preferably 3 to 15 nm. As above-mentioned, the alkaline colloidal silica particles show the effect of inhibiting occurrence of the background contamination. Accordingly, the use of the alkaline colloidal silica particles is particularly preferable. Examples of the alkaline colloidal silica particles having the average particle size within the foregoing range include Snowtex-20 (average particle size: 10 to 20 nm), Snowtex-30 (average particle size: 10 to 20 nm), Snowtex-40 (average particle size: 10 to 20 nm), Snowtex-N (average particle size: 10 to 20 nm), Snowtex-S (average particle size: 8 to 11 nm) and Snowtex-XS (average particle size: 4 to 6 nm), each produced by Nissan Kagaku Co., Ltd.

The colloidal silica particles having an average particle size of not more than 20 nm, when used together with the necklace-shaped colloidal silica as described above, is particularly preferred, since porosity of the layer is maintained and the layer strength is further increased.

The ratio of the colloidal silica particles having an average particle size of not more than 20 nm to the necklace-shaped colloidal silica is preferably from 95/5 to 5/95, more preferably from 70/30 to 20/80, and most preferably from 60/40 to 30/70.

(Porous Metal Oxide Particles)

The hydrophilic layer in the invention contains porous metal oxide particles having a particle size less than 1 μm.

(Porous Metal Oxide Particles)

Examples of the porous metal oxide particles include porous silica particles, porous aluminosilicate particles or zeolite particles as described later.

(Porous Silica or Porous Aluminosilicate Particles)

The porous silica particles are ordinarily produced by a wet method or a dry method. By the wet method, the porous silica particles can be obtained by drying and pulverizing a gel prepared by neutralizing an aqueous silicate solution, or pulverizing the precipitate formed by neutralization. By the dry method, the porous silica particles are prepared by combustion of silicon tetrachloride together with hydrogen and oxygen to precipitate silica. The porosity and the particle size of such particles can be controlled by variation of the production conditions. The porous silica particles prepared from the gel by the wet method is particularly preferred.

The porous aluminosilicate particles can be prepared by the method described in, for example, JP O.P.I. No. 10-71764. Thus prepared aluminosilicate particles are amorphous complex particles synthesized by hydrolysis of aluminum alkoxide and silicon alkoxide as the major components. The particles can be synthesized so that the ratio of alumina to silica in the particles is within the range of from 1:4 to 4:1. Complex particles composed of three or more components prepared by an addition of another metal alkoxide may also be used in the invention. In such a particle, the porosity and the particle size can be controlled by adjustment of the production conditions.

The porosity of the particles is preferably not less than 1.0 ml/g, more preferably not less than 1.2 ml/g, and most preferably of from 1.8 to 2.5 ml/g, in terms of pore volume. The pore volume is closely related to water retention of the coated layer. As the pore volume increases, the water retention is increased, contamination is difficult to occur, and the water retention latitude is broad. Particles having a pore volume of more than 2.5 ml/g are brittle, resulting in lowering of durability of the layer containing them. Particles having a pore volume of less than 0.5 ml/g may be insufficient in printing performance.

(Measurement of Pore Volume)

Measurement of the pore volume is carried out employing AUTOSORB-1 produced by Quantachrome Co., Ltd. Assuming that the voids of particles are filled with a nitrogen gas, the pore volume is calculated from a nitrogen gas adsorption amount at a relative pressure of 0.998.

(Zeolite Particles)

Zeolite is a crystalline aluminosilicate, which is a porous material having voids of a regular three dimensional net work structure and having a pore size of 0.3 to 1 nm.

The hydrophilic matrix phase constituting the hydrophilic layer in the invention can contain layer structural clay mineral particles as a metal oxide.

Examples of the layer structural clay mineral particles include a clay mineral such as kaolinite, halloysite, talk, smectite such as montmorillonite, beidellite, hectorite and saponite, vermiculite, mica and chlorite; hydrotalcite; and a layer structural polysilicate such as kanemite, makatite, ilerite, magadiite and kenyte. Among them, ones having a higher electric charge density of the unit layer are higher in the polarity and in the hydrophilicity. Preferable charge density is not less than 0.25, more preferably not less than 0.6. Examples of the layer structural mineral particles having such a charge density include smectite having a negative charge density of from 0.25 to 0.6 and bermiculite having a negative charge density of from 0.6 to 0.9. Synthesized fluorinated mica is preferable since one having a stable quality, such as the particle size, is available. Among the synthesized fluorinated mica, swellable one is preferable and one freely swellable is more preferable.

An intercalation compound of the foregoing layer structural mineral particles such as a pillared crystal, or one treated by an ion exchange treatment or a surface treatment such as a silane coupling treatment or a complication treatment with an organic binder is also usable.

With respect to the size of the planar structural mineral particles, the particles have an average particle size (an average of the largest particle length) of preferably not more than 20 μm, and more preferably not more than 10 μm, and an average aspect ratio (the largest particle length/the particle thickness of preferably not less than 20, and more preferably not less than 50, in a state contained in the layer including the case that the particles are subjected to a swelling process and a dispersing layer-separation process. When the particle size is within the foregoing range, continuity to the parallel direction, which is a trait of the layer structural particle, and softness, are given to the coated layer so that a strong dry layer in which a crack is difficult to be formed can be obtained. The coating solution containing the layer structural clay mineral particles in a large amount can minimize particle sedimentation due to a viscosity increasing effect. The particle size greater than the foregoing may produce a non-uniform coated layer, resulting in poor layer strength. The aspect ratio lower than the foregoing reduces the planar particles, resulting in insufficient viscosity increase and reduction of particle sedimentation inhibiting effect.

The content of the layer structural clay mineral particles is preferably from 0.1 to 30% by weight, and more preferably from 1 to 10% by weight based on the total weight of the layer. Particularly, the addition of the swellable synthesized fluorinated mica or smectite is effective if the adding amount is small. The layer structural clay mineral particles may be added in the form of powder to a coating liquid, but it is preferred that gel of the particles which is obtained by being swelled in water, is added to the coating liquid in order to obtain a good dispersity according to an easy coating liquid preparation method which requires no dispersion process comprising dispersion due to media.

An aqueous solution of a silicate is also usable as another additive to the hydrophilic matrix phase. An alkali metal silicate such as sodium silicate, potassium silicate or lithium silicate is preferable, and the SiO₂/M₂O is preferably selected so that the pH value of the coating liquid after addition of the silicate exceeds 13 in order to prevent dissolution of the porous metal oxide particles or the colloidal silica particles.

An inorganic polymer or an inorganic-organic hybrid polymer prepared by a sol-gel method employing a metal alkoxide. Known methods described in S. Sakka “Application of Sol-Gel Method” or in the publications cited in the above publication can be applied to prepare the inorganic polymer or the inorganic-organic hybrid polymer by the sol-gel method.

The hydrophilic layer may contain a water-soluble resin.

Examples of the water-soluble resin include polysaccharides, polyethylene oxide, polypropylene oxide, polyvinyl alcohol, polyethylene glycol (PEG), polyvinyl ether, a styrene-butadiene copolymer, a conjugation diene polymer latex of methyl methacrylate-butadiene copolymer, an acryl polymer latex, a vinyl polymer latex, polyacrylamide, and polyvinyl pyrrolidone. In the invention, polysaccharides are preferably used as the water soluble resin.

As the polysaccharide, starches, celluloses, polyuronic acid and pullulan can be used. Among them, a cellulose derivative such as a methyl cellulose salt, a carboxymethyl cellulose salt or a hydroxyethyl cellulose salt is preferable, and a sodium or ammonium salt of carboxymethyl cellulose is more preferable. These polysaccharides can form a preferred surface shape of the hydrophilic layer.

The surface of the hydrophilic layer preferably has a convexoconcave structure having a pitch of from 0.1 to 50 μm as the grained aluminum surface of an aluminum PS plate. The water retention ability and the image maintaining ability are raised by such a convexoconcave structure of the surface. Such a convexoconcave structure can also be formed by adding in an appropriate amount a filler having-a suitable particle size to the coating liquid of the hydrophilic layer. However, the convexoconcave structure is preferably formed by coating a coating liquid for the hydrophilic layer containing the alkaline colloidal silica and the water-soluble polysaccharide so that the phase separation occurs at the time of drying the coated liquid, whereby a structure is obtained which provides a good printing performance.

The shape of the convexoconcave structure such as the pitch and the surface roughness thereof can be suitably controlled by the kinds and the adding amount of the alkaline colloidal silica particles, the kinds and the adding amount of the water-soluble polysaccharide, the kinds and the adding amount of another additive, a solid concentration of the coating liquid, a wet layer thickness or a drying condition.

In the invention, it is preferred that the water soluble resin contained in the hydrophilic matrix phase is water soluble, and at least a part of the resin exists in the hydrophilic layer in a state capable of being dissolved in water. If a water soluble carbon atom-containing material is cross-linked by a crosslinking agent and is insoluble in water, its hydrophilicity is lowered, resulting in problem of lowering printing performance. A cationic resin may also be contained in the hydrophilic layer. Examples of the cationic resin include a polyalkylene-polyamine such as a polyethyleneamine or polypropylenepolyamine or its derivative, an acryl resin having a tertiary amino group or a quaternary ammonium group and diacrylamine. The cationic resin may be added in a form of fine particles. Examples of such particles include the cationic microgel described in Japanese Patent O.P.I. Publication No. 6-161101.

A water-soluble surfactant may be added for improving the coating ability of the coating liquid for the hydrophilic layer in the invention. A silicon atom-containing surfactant and a fluorine atom-containing surfactant are preferably used. The silicon atom-containing surfactant is especially preferred in that it minimizes printing contamination. The content of the surfactant is preferably from 0.01 to 3% by weight, and more preferably from 0.03 to 1% by weight based on the total weight of the hydrophilic layer (or the solid content of the coating liquid).

The hydrophilic layer in the invention can contain a phosphate. Since a coating liquid for the hydrophilic layer is preferably alkaline, the phosphate to be added to the hydrophilic layer is preferably sodium phosphate or sodium monohydrogen phosphate. The addition of the phosphate provides improved reproduction of dots at shadow portions. The content of the phosphate is preferably from 0.1 to 5% by weight, and more preferably from 0.5 to 2% by weight in terms. of amount excluding hydrated water.

The thickness of the hydrophilic layer is preferably from 0.1 to 20 μm, and more preferably from 0.2 to 15 μm.

(Light-to-Heat Conversion Material)

The image formation layer, hydrophilic layer, hydrophilic overcoat layer or another layer in the invention can contain a light heat conversion material. Examples of the light heat conversion material include the following substances:

(Infrared Absorbing Dye)

Examples of the light-heat conversion material include a general infrared absorbing dye such as a cyanine dye, a chloconium dye, a polymethine dye, an azulenium dye, a squalenium dye, a thiopyrylium dye, a naphthoquinone dye or an anthraquinone dye, and an organometallic complex such as a phthalocyanine compound, a naphthalocyanine compound, an azo compound, a thioamide compound, a dithiol compound or an indoaniline compound. Exemplarily, the light-heat conversion materials include compounds disclosed in Japanese Patent O.P.I. Publication Nos. 63-139191, 64-33547, 1-160683, 1-280750, 1-293342, 2-2074, 3-26593, 3-30991, 3-34891, 3-36093, 3-36094, 3-36095, 3-42281, 3-97589 and 3-103476. These compounds may be used singly or in combination.

Examples of pigment include carbon, graphite, a metal and a metal oxide.

Furnace black and acetylene black is preferably used as the carbon. The graininess (d₅₀) thereof is preferably not more than 100 nm, and more preferably not more than 50 nm.

The graphite is one having a particle size of preferably not more than 0.5 μm, more preferably not more than 100 nm, and most preferably not more than 50 nm.

As the metal, any metal can be used as long as the metal is in a form of fine particles having preferably a particle size of not more than 0.5 μm, more preferably not more than 100 nm, and most preferably not more than 50 nm. The metal may have any shape such as spherical, flaky and needle-like. Colloidal metal particles such as those of silver or gold are particularly preferred.

As the metal oxide, materials having black color in the visible regions, or electro-conductive materials or semi-conductive materials can be used. Examples of the materials having black color in the visible regions include black iron oxide (Fe₃O₄), and black complex metal oxides containing at least two metals. Black complex metal oxides comprised of at least two metals are preferred. Typically, the black complex metal oxides include complex metal oxides comprising at least two selected from Al, Ti, Cr, Mn, Fe, Co, Ni, Cu, Zn, Sb, and Ba. These can be prepared according to the methods disclosed in Japanese Patent O.P.I. Publication Nos. 9-27393, 9-25126, 9-237570, 9-241529 and 10-231441. The complex metal oxide used in the invention is preferably a complex Cu—Cr—Mn type metal oxide or a Cu—Fe—Mn type metal oxide. The Cu—Cr—Mn type metal oxides are preferably subjected to the treatment disclosed in Japanese Patent O.P.I. Publication Nos. 8-27393 in order to reduce isolation of a 6-valent chromium ion. These complex metal oxides have a high color density and a high light heat conversion efficiency as compared with another metal oxide. The primary average particle size of these complex metal oxides is preferably from 0.001 to 1.0 μm, and more preferably from 0.01 to 0.5 μm. The primary average particle size of from 0.001 to 1.0 μm improves a light heat conversion efficiency relative to the addition amount of the particles, and the primary average particle size of from 0.05 to 0.5 μm further improves a light heat conversion efficiency relative to the addition amount of the particles. The light heat conversion efficiency relative to the addition amount of the particles depends on a dispersity of the particles, and the well-dispersed particles have a high light heat conversion efficiency. Accordingly, these complex metal oxide particles are preferably dispersed according to a known dispersing method, separately to a dispersion liquid (paste), before being added to a coating liquid for the particle containing layer. The metal oxides having a primary average particle size of less than 0.001 are not preferred since they are difficult to disperse. A dispersant is optionally used for dispersion. The addition amount of the dispersant is preferably from 0.01 to 5% by weight, and more preferably from 0.1 to 2% by weight, based on the weight of the complex metal oxide particles. Kinds of the dispersant are not specifically limited, but the dispersant is preferably a silicon-contained surfactant.

Examples of the electro-conductive materials or semi-conductive materials include Sb-doped SnO₂ (ATO), Sn-added In₂O₃ (ITO), TiO₂, TiO prepared by reducing TiO₂ (titanium oxide nitride, generally titanium black). Particles prepared by covering a core material such as BaSO₄, TiO₂, 9Al₂O₃.2B₂O and K₂O.nTiO₂ with these metal oxides is usable. The particle size of these particles is preferably not more than 0.5 μm, more preferably not more than 100 nm, and most preferably not more than 50 nm.

The especially preferred light heat conversion materials are the above-described infrared absorbing dyes or the black complex metal oxides comprised of at least two metal oxides.

The addition amount of the light heat conversion materials is preferably 0.1 to 50% by weight, more preferably 1 to 30% by weight, and most preferably 3 to 25% by weight based on the weight of the layer to which the material are added.

(Hydrophilic Overcoat Layer)

In the invention, a hydrophilic overcoat layer is preferably provided on the image formation layer, in order to prevent flaws from occurring during handling.

The hydrophilic overcoat layer may be provided directly or through an intermediate layer on the image formation layer. It is preferred that the hydrophilic overcoat layer can be removed on a printing press.

In the invention, it is preferred that the hydrophilic overcoat layer contains a water soluble resin or a water swellable resin in which a water soluble resin is partly cross-linked. The water soluble resin is the same as those used in the image formation layer. Examples of the water-soluble resin include polysaccharides, polyethylene oxide, polypropylene oxide, polyvinyl alcohol, polyethylene glycol (PEG), polyvinyl ether, a styrene-butadiene copolymer, a conjugation diene polymer latex of methyl methacrylate-butadiene copolymer, an acryl polymer latex, a vinyl polymer latex, polyacrylamide, and polyvinyl pyrrolidone. In the invention, polysaccharides are preferably used as the water-soluble resin. As the polysaccharide, starches, celluloses, polyuronic acid and pullulan can be used. Among them, a cellulose derivative such as a methyl cellulose salt, a carboxymethyl cellulose salt or a hydroxyethyl cellulose salt is preferable, and a sodium or ammonium salt of carboxymethyl cellulose is more preferable. These polysaccharides can form a preferred surface shape of the hydrophilic layer.

In the invention, the hydrophilic overcoat layer can contain a light-to-heat conversion material described above.

The overcoat layer in the invention preferably contains a matting agent with an average size of from 1 to 20 μm, in order to prevent flaws from occurring while the printing plate material is mounted on a laser apparatus or on a printing press.

The matting agent is preferably inorganic particles having a new Mohs hardness of not less than 5 or an organic matting agent. Examples of the inorganic particles having a new Mohs hardness of not less than 5 include particles of metal oxides (for example, silica, alumina, titania, zirconia, iron oxides, chromium oxide), particles of metal carbides (for example, silicon carbide), boron nitride particles, and diamond particles.

Examples of the organic matting agent include starch described in U.S. Pat. No. 2,322,037, starch derivatives described in BE 625,451 and GB 981,198, Polyvinyl alcohol described in JP-B-44-3643, polystyrene or polymethacrylate described in CH 330,158, polyacrylonitrile described in U.S. Pat. No. 3,079,257, and polycarbonate described in U.S. Pat. No. 3,022,169.

The adding amount of the matting agent in the overcoat layer is preferably from 0.1 g to less than 10 g per m².

A coating solution for the overcoat layer may contain a nonionic surfactant in order to secure uniform coatability of the overcoat layer. Examples of the nonionic surfactant include sorbitan tristearate, sorbitan monopalmitate, sorbitan trioleate, stearic acid monoglyceride, polyoxyethylenenonylphenyl ether, and polyoxyethylenedodecyl ether. The content of the nonionic surfactant is preferably 0.05 to 5% by weight, and more preferably 1 to 3% by weight based on the total solid content of the overcoat layer.

In the invention, the dry thickness of the overcoat layer is preferably 0.05 to 1.5 g/m², and more preferably 0.1 to 0.7 g/m². This content range prevents occurrence of staining or scratches or deposition of fingerprints, and minimizes ablation scum without impairing removability of the overcoat layer.

(Visualization)

Before a printing plate with an image is mounted on a printing press for printing, there is usually a plate inspection process for examining if the image is correctly formed on the printing plate. When the plate inspection process is carried out, it is preferred that a printing plate before printing has a property in which an image formed on the printing plate is visible, that is, image visibility. It is preferred that the optical density of exposed portions in the printing plate material varies by light or heat generated on exposure.

As a method for providing image visibility to a printing plate material in the invention, there is a method employing a cyanine type infrared light absorbing dye, which varies its optical density on exposure, a method employing a combination of a photo-induced acid generating agent and a compound varying its color by an acid, a method employing a combination of a color forming agent such as a leuco dye and a color developing agent, or a method employing property in which the milky heat-melting or heat-fusible particles are made transparent on light exposure.

<<Structural Layer of the Support Opposite the Image Formation Layer>>

In the printing plate material of the invention having a plastic film as the support, it is preferred that at least one structural layer is provided on the surface of the support opposite the image formation layer, in order to improve handling properties and minimize change in physical properties during storage. A preferred structural layer is a subbing layer, a hydrophilic binder-containing layer, or a hydrophobic binder-containing layer. The binder-containing layer may be provided on the subbing layer.

The subbing layer is preferably the subbing layer of the support described above.

The hydrophilic binder may be any as long as it exhibits hydrophilicity, and examples of the hydrophilic binder include resins having, asia hydrophilic group, a hydroxyl group such as polyvinyl alcohol (PVA), cellulose resins (methylcellulose MC, ethylcellulose EC, hydroxyethylcellulose HEC, carboxymethylcellulose CMC), chitins, or starch; resins having an ether bond such as polyethylene oxide PEO, polypropylene oxide PPO, polyethylene glycol PEG, or polyvinyl ether PVE; resins having an amide group or an amide bond such as polyacryl amide PAAM or polyvinyl pyrrolidone PVP; resins having as a dissociation group a carboxyl group such as polyacrylic acid salts, maleic acid resins, alginates or gelatins; polystyrene sulfonic acid salt; resins having an amino group, an imino group, a tertiary amino group or a quaternary ammonium group such as polyallylamine PAA, polyethylene imine PEI, epoxidated polyamide EPAM, polyvinyl pyridine or gelatins.

The hydrophobic binder may be any as long as it exhibits hydrophobicity, and examples of the hydrophobic binder include polymers derived from α,β-ethylenically unsaturated monomers such as polyvinyl chloride, chlorinated polyvinyl chloride, a copolymer of vinyl chloride and vinylidene chloride, a copolymer of vinyl chloride, and vinyl acetate, polyvinyl acetate, partially saponified polyvinyl acetate, polyvinyl acetal or preferably polyvinyl butyral in which a part of polyvinyl alcohol is acetalized with aldehyde, a copolymer of acrylonitrile and acryl amide, polyacrylates, polymethacrylates, polystyrene, polyethylene and a mixture thereof.

The hydrophobic binder may be water dispersible resins disclosed in Japanese Patent O.P.I. Publication No. 2002-258469, sections [0033] through [0038], as long as it can make the surface of the printing plate material hydrophobic.

It is preferred that the outermost structure layer contains a matting agent with an average particle size of from 1 μm to less than 20 μm, in order to easily mount the printing plate on a printing press and to prevent “out of color registration” due to “out of registration” of the printing plate during printing.

The matting agent is preferably inorganic particles having a new Mohs hardness of not less than 5 or an organic matting agent. Examples of the inorganic particles having a new Mohs hardness of not less than 5 include particles of metal oxides (for example, silica, alumina, titania, zirconia, iron oxides, chromium oxide), particles of metal carbides (for example, silicon carbide), boron nitride particles, and diamond particles. Examples of the organic matting agent include starch described in U.S. Pat. No. 2,322,037, starch derivatives described in BE 625,451 and GB 981,198, Polyvinyl alcohol described in JP-B-44-3643, polystyrene or polymethacrylate described in CH 330,158, polyacrylonitrile described in U.S. Pat. No. 3,079,257, and polycarbonate described in U.S. Pat. No. 3,022,169.

The adding amount of the matting agent in the overcoat layer is preferably from 0.1 g to less than 10 g per m².

The surface roughness of the structural layer of the support opposite the image formation layer can be adjusted by the particle size or addition amount of the matting agent or the content of the binder. The structural layer has a surface roughness Ra of preferably from 0.1 μm to less than 2 μm. The surface roughness less than 0.1 μm of the structural layer may result in poor transportability due to high coefficient of friction of the printing plate material or may cause any problem on mounting the printing plate material on a plate cylinder. The surface roughness more than 2 μm may scratch the surface of the support opposite the structural layer when the printing plate material is wound around a spool in its manufacturing process or another process, and may partially protrude the surface of the printing plate material due to such a coarse surface of the structural layer, resulting in poor printing durability due to excessive printing pressure applied to the protrusion portions.

A laser recording apparatus or a processless printing press has a sensor for controlling transportation of the printing plate material. In the invention, in order to carry out the controlling smoothly, the structural layer preferably contains dyes or pigment. The dyes or pigment are preferably infrared absorbing dyes or pigment as described above used as a light-to-heat conversion material. The structural layer can further contain a surfactant.

(Packaging Material)

The printing plate material having a plastic film support was cut into an intended size, wound around a roll, packed in a packaging material, and stored till the material is subjected to exposure for image formation as described later.

The printing plate material is preferably wound around a core with a diameter of from 4 to 10 cm. In order to endure a long term storage, the packaging material is preferably one having an oxygen permeability of not more than 5×10⁻⁶ ml/Pa·m²·30° C.·day as disclosed in Japanese Patent O.P.I. Publication No. 2000-206653. As another embodiment, the packaging material is also preferred which has a moisture permeability of not more than 10⁻⁶ g/Pa·m²·30° C.·day as disclosed in Japanese Patent O.P.I. Publication No. 2000-206653.

(Exposure)

In the invention, a printing plate is prepared by exposing the image formation layer of the processless printing plate material described above to laser light according to the image information ton form an image.

The exposure in the invention is preferably scanning exposure, which is carried out employing a laser which can emit light having a wavelength of infrared and/or near-infrared regions, that is, a wavelength of from 700 to 1500 nm. As the laser, a gas laser can be used, but a semi-conductor laser, which emits light having a near-infrared region wavelength, is preferably used.

A device suitable for the scanning exposure in the invention may be any device capable of forming an image on the printing plate material according to image signals from a computer employing a semi-conductor laser.

Generally, the following scanning exposure processes are mentioned.

(1) A process in which a plate precursor provided on a fixed horizontal plate is scanning exposed in two dimensions, employing one or several laser beams.

(2) A process in which the surface of a plate precursor provided along the inner peripheral wall of a fixed cylinder is subjected to scanning exposure in the rotational direction (in the main scanning direction) of the cylinder, employing one or several lasers located inside the cylinder, moving the lasers in the normal direction (in the sub-scanning direction) to the rotational direction of the cylinder.

(3) A process in which the surface of a plate precursor provided along the outer peripheral wall of a fixed cylinder is subjected to scanning exposure in the rotational direction (in the main scanning direction) of the cylinder, employing one or several lasers located inside the cylinder, moving the lasers in the normal direction (in the sub-scanning direction) to the rotational direction of the cylinder.

In the invention, the process (3) above is preferable, and especially preferable when a printing plate material mounted on a plate cylinder of a printing press is scanning exposed.

Employing the thus printing plate material after image recording, printing is carried out without a special development process. After the printing plate material is imagewise exposed and mounted on a plate cylinder of a printing press, or after the printing plate material is mounted on the cylinder and then imagewise heated to obtain a printing plate material, a dampening water supply roller and/or an ink supply roller are brought into contact with the surface of the resulting printing plate material while rotating the plate cylinder to remove non-image portions of the component layer of the printing plate material (so-called, development on press).

When a printing plate for printing is prepared from the processless printing plate material in the invention, non-image portion removal (after image recording) in the printing plate material can be carried out by the same printing sequences as those in conventional PS plates (development on press), whereby a printing image is formed. In the invention, development on press is preferably carried out.

It is preferred that the printing method of the invention comprises a step of drying a printing plate material, between the image recording (formation) step and a step of contacting a dampening water supply roller and/or an ink supply roller with the surface of the printing plate material.

### EXAMPLES

The present invention will be detailed employing the following examples, but the invention is not limited thereto. In the examples, “parts” represents parts by weight, unless otherwise specified.

<<Preparation of Polyethylene Terephthalate Support>>

(Preparation of Support 1)

Employing terephthalic acid and ethylene glycol, polyethylene terephthalate having an intrinsic viscosity VI of 0.66 (at 25° C. in a phenol/tetrachloroethane (6/4 by weight) solvent) was prepared according to a conventional method. The resulting polyethylene terephthalate was formed into pellets, dried at 130° C. for 4 hours, and melted at 300° C. The melted polyethylene terephthalate was extruded from a T-shaped die onto a 50° C. drum, and rapidly cooled. Thus, an unstretched film sheet having a thickness, which provided an average thickness of 175 μm after heat fixing, was obtained. The film sheet was stretched in the mechanical direction at 102° C. by a stretching magnification of 1.3, and then at 110° C. by a stretching magnification of 2.6. Successively, the stretched film sheet was further stretched at 120° C. by a stretching magnification of 4.5 in the transverse direction in a tenter. The resulting sheet was heat fixed at 240° C. for 20 seconds and relaxed at 240° C. in the transverse direction by 4%. Thereafter, the sheet at the chuck portions in the tenter was cut off, and the both edges of the sheet were subjected to knurling treatment. The knurled sheet was cooled to 40° C., and wound around an up-take spool at a tension of 47.1 N/m. Thus, a 175 μm thick biaxially stretched polyethylene terephthalate film sheet (Support 1) was prepared. This polyethylene terephthalate film sheet had a glass transition temperature (Tg) of 79° C. The width of the polyethylene terephthalate film sheet had a width of 2.5 m. The thickness distribution of Support 1 was 3%.

<<Preparation of Subbed Support Sample>>

One surface of the support 1 prepared above was subjected to corona discharge treatment at 0.05 kV·A·min/m². The following subbing layer coating solution c-1 was coated the one surface to obtain a first subbing layer with a dry thickness of 0.06 μm, and dried at 140° C. Subsequently, the following subbing layer coating solution d-1 was coated on the first subbing layer to be a second subbing layer with a dry thickness of 0.2 μm, and dried at 140° C. (subbing layer surface B).

<<Subbing Layer Coating Solution c-1 Containing Conductive Material>>

| | |
|---|---|
| Latex of styrene/glycidyl methacrylate/ | 16.0 g |
| butyl acrylate (20/40/40) copolymer | |
| (30% in terms of solid content) | |
| Latex of styrene/butyl acrylate/ | 4.0 g |
| hydroxymethyl methacrylate (25/45/30) copolymer | |
| (30% in terms of solid content) | |
| SnO₂ sol (10% in terms of solid content) | 9.1 g |
| (synthesized by the method described in Example 1 | |
| in Japanese Patent O.P.I. publication | |
| No. 10-059720) | |
| Anionic surfactant S-1 | 0.5 g |

Distilled water was added to make a coating solution of 1000 ml.

<<Subbing Layer Coating Solution d-1>>

| | |
|---|---|
| Modified polyester A | 215.0 g |
| (See below. 18% in terms of solid content) | |
| Anionic surfactant S-1 | 0.4 g |
| Spherical silica SEAHOSTAR KE-P50 (produced by | 0.3 g |
| Nippon Shokubai Co., Ltd.) | |

Distilled water was added to make a coating solution of 1000 ml (having a solid content of 0.5%).

<<Modified Polyester A>>
Aqueous Dispersion of Water-Soluble Copolyester Component/Acryl Component (80/20)

The water-soluble copolyester component is a copolyester derived from terephthalic acid/isophthalic acid/cyclohexane dicarboxylic acid/dimethyl 5-sodiumsulfoisophthalate (40/38/14/8) as dicarboxylic acid and ethylene glycol as diol. The acryl component is latex of methyl methacrylate/ethyl acrylate/glycidyl methacrylate (53/37/10) copolymer.

Successively, the other surface of the support opposite the above subbing layer was subjected to corona discharge treatment with 0.05kV·A·min/m². Subsequently, the following subbing layer coating solution a was coated on the resulting surface to give a third subbing layer with a dry thickness of 0.25 μm, and the following subbing layer coating solution b was coated on the third layer to give a fourth layer with a dry thickness of 0.06 μm, and dried at 140° C. (subbing layer surface A). The resulting support was heat fixed at 125° C. for 2 minutes to prepare a subbed support sample.

<<Subbing Layer Coating Solution a>>

| | |
|---|---|
| Latex of styrene/glycidyl methacrylate/ | 56.3 g |
| butyl acrylate (20/40/40) copolymer | |
| (30% in terms of solid content) | |
| Latex of styrene/glycidyl methacrylate/ | 210 g |
| butyl acrylate (59.7/39.8/0.5) copolymer | |
| (30% in terms of solid content) | |
| Anionic surfactant S-1 (2% aqueous solution) | 30 g |

Distilled water was added to make coating solution a of 1000 ml.

<<Subbing Layer Coating Solution b>>

| | |
|---|---|
| Modified polyester B (See below. | 31 g |
| 21.7% in terms of solid content) | |
| Anionic surfactant S-1 | 5.7 g |
| Spherical silica matting agent SEAHOSTAR KE-P50 | 1.9 g |
| (produced by Nippon Shokubai Co., Ltd.) | |
| Aqueous solution in which F-1 of 250 ppm was | 57.7 g |
| added into ethylene copolymer polyvinyl alcohol | |
| (RS2117 produced by Kuraray Co., Ltd.) | |
| (5% in terms of solid content) | |
| Hardener H-1 (0.5% solid content aqueous solution) | 50 g |

Distilled water was added to make subbing layer coating solution b of 1000 ml.

<<Modified Polyester B>>
Aqueous Dispersion of Water-Soluble Copolyester Component/Acryl Component (64/36)

The water-soluble copolyester component is a copolymer derived from terephthalic acid/isophthalic acid/cyclohexane dicarboxylic acid/dimethyl 5-sodiumsulfoisophthalate (40/38/14/8) as dicarboxylic acid and ethylene glycol as diol. The acryl component is latex of styrene/glycidyl methacrylate/butyl acrylate/acetoacetoxyethyl metacrylate (39.5/40/20/0.5) copolymer. 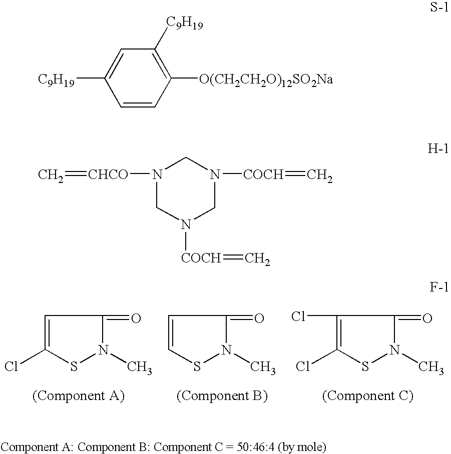
<<Heat Treatment of Subbed Support Sample>>

The subbed support sample was slit to obtain a width of 1.25 m, and subjected to heat treatment (low tension heat treatment) at a tension of 2 hPa at 180° C. for one minute.

<<Preparation of Printing Plate Material Sample>>

The subbed support sample was dried at 100° C. for 30 seconds immediately before coating a hydrophilic layer, and covered with a moisture proof sheet so as not to contact moisture in air to obtain a covered support. The moisture content of the support was measured to be 0.2%. The covered support, immediately after uncovered, was coated with a hydrophilic layer.

A hydrophilic layer 1 coating solution shown in Table 1 (the preparation method will be described later) and a hydrophilic layer 2 coating solution shown in Table 2 (the preparation method will be described later) were coated on the subbing layer surface A of the resulting support sample with a wire bar. That is, the hydrophilic layer 1 coating solution and the hydrophilic layer 2 coating solution were coated on the subbing layer surface A in that order, dried at 120° C. for 3 minutes, and further heat treated at 60° C. for 24 hours.

Thereafter, the image formation layer coating solution shown in Table 3 (the preparation method will be described later) was coated with a wire bar on the resulting hydrophilic layer, and then the outermost backing layer coating solution shown in Table 4 (the preparation method will be described later) was coated with a wire bar on the subbing layer surface B, dried at 50° C. for 3 minutes, and further subjected to seasoning treatment at 50° C. for 72 hours. Thus, a printing plate material sample was prepared.

[Preparation of Hydrophilic Layer 1 Coating Solution]

The materials as shown in Table 1 were sufficiently mixed in the amounts shown in Table 1 while stirring, employing a homogenizer, and filtered to obtain hydrophilic layer 1 coating solution. In Table 1, numerical values represent content per m².

TABLE 1

| | Weight | |
|---|---|---|
| Materials | per m² | |
| Colloidal silica (alkali type): Snowtex XS (solid 20% | 1.2 | g |
| by weight, produced by Nissan Kagaku Co., Ltd.) | | |
| Colloidal silica (alkali type): Snowtex ZL (solid 40% | 80 | mg |
| by weight, produced by Nissan Kagaku Co., Ltd.) | | |
| STM-6500S produced by Nissan Kagaku Co., Ltd. | 0.1 | g |
| (spherical particles comprised of melamine resin as | | |
| cores and silica as shells with an average particle | | |
| size of 6.5 μm and having a convexo-concave surface) | | |
| Porous metal oxide particles Silton JC 50 (porous | 0.3 | g |
| aluminosilicate particles having an average particle | | |
| size of 5 μm, produced by Mizusawa Kagaku Co., Ltd.) | | |
| Cu-Fe-Mn type metal oxide black pigment: TM-3550 | 0.5 | g |
| black aqueous dispersion {prepared by dispersing TM- | | |
| 3550 black powder having a particle size of 0.1 μm | | |
| produced by Dainichi Seika Kogyo Co., Ltd. in water | | |
| to give a solid content of 40% by weight (including | | |
| 0.2% by weight of dispersant)} | | |
| Layer structural clay mineral particles: | 30 | mg |
| Montmorillonite Mineral Colloid MO gel prepared by | | |
| vigorously stirring montmorillonite Mineral Colloid | | |
| MO; gel produced by Southern Clay Products Co., Ltd. | | |
| (average particle size: 0.1 μm) in water in a | | |
| homogenizer to give a solid content of 5% by weight | | |
| Aqueous 4% by weight sodium carboxymethyl cellulose | 10 | mg |
| solution (Reagent produced by Kanto Kagaku Co., Ltd.) | | |
| Aqueous 10% by weight sodium phosphate.dodecahydrate | 6 | mg |
| solution (Reagent produced by Kanto Kagaku Co., Ltd.) | | |
| Porous metal oxide particles Silton JC 40 (porous | 0.5 | mg |
| aluminosilicate particles having an average particle | | |
| size of 4 μm, produced by Mizusawa Kagaku Co., Ltd.) | | |
| Silicon-containing surfactant: FZ2161 (Nippon Unicar | 50 | mg |
| Co., Ltd.) | | |

[Preparation of Hydrophilic Layer 2 Coating Solution]

The materials as shown in Table 2 were sufficiently mixed in the amounts shown in Table 2 while stirring, employing a homogenizer, and filtered to obtain hydrophilic layer 1 coating solution. In Table 2, numerical values represent content per m².

TABLE 2

| | Weight | |
|---|---|---|
| Materials | per m² | |
| Colloidal silica (alkali type): Snowtex XS (solid 20% | 1.2 | g |
| by weight, produced by Nissan Kagaku Co., Ltd.) | | |
| Colloidal silica (alkali type): Snowtex ZL (solid 40% | 80 | mg |
| by weight, produced by Nissan Kagaku Co., Ltd.) | | |
| STM-6500S produced by Nissan Kagaku Co., Ltd. | 0.4 | g |
| (spherical particles comprised of melamine resin as | | |
| cores and silica as shells with an average particle | | |
| size of 6.5 μm and having a convexoconcave surface) | | |
| Cu-Fe-Mn type metal oxide black pigment: TM-3550 | 0.5 | g |
| black aqueous-dispersed substance {prepared by | | |
| dispersing TM-3550 black powder having an a particle | | |
| size of about 0.1 μm produced by Dainichi Seika Kogyo | | |
| Co., Ltd. in water to give a solid content of 40% by | | |
| weight (including 0.2% by weight of dispersant)} | | |
| Layer structural clay mineral particles: | 30 | mg |
| Montmorillonite Mineral Colloid MO gel prepared by | | |
| vigorously stirring montmorillonite Mineral Colloid | | |
| MO; gel produced by Southern Clay Products Co., Ltd. | | |
| (average particle size: 0.1 μm) in water in a | | |
| homogenizer to give a solid content of 5% by weight | | |
| Aqueous 4% by weight sodium carboxymethyl cellulose | 10 | mg |
| solution (Reagent produced by Kanto Kagaku Co., Ltd.) | | |
| Aqueous 10% by weight sodium phosphate.dodecahydrate | 6 | mg |
| solution (Reagent produced by Kanto Kagaku Co., Ltd.) | | |
| Porous metal oxide particles Silton JC-40 (porous | 0.3 | g |
| aluminosilicate particles having an average particle | | |
| size of 4 μm, produced by Mizusawa Kagaku Co., Ltd.) | | |
| Hydroxyether modified starch (PENON JE66 produced by | 10 | mg |
| Nippon Starch Chemical Co., Ltd.) | | |
| Silicon-containing surfactant: FZ2161 (Nippon Unicar | 50 | mg |
| Co., Ltd.) | | |

[Preparation of Image Formation Layer Coating Solution]

The materials for the image formation layer coating solution were diluted with pure water and dispersed to prepare an image formation layer coating solution. In Table 3, numerical values represent content by weight per m².

TABLE 3

| | Weight |
|---|---|
| Materials | per m² |
| Dispersion liquid prepared by diluting with pure | 350 mg |
| water carnauba wax emulsion A118 (having a solid | |
| content of 40% by weight, the wax having an average | |
| particle size of 0.25 μm, a melting viscosity at 140° | |
| C. of 8 cps, a softening point of 65° C., and a melting | |
| point of 80° C., produced by Gifu Shellac Co., Ltd.) | |
| to give a solid content of 5% by weight | |
| Microcrystalline wax emulsion A206 (having a solid | 150 mg |
| content of 40% by weight and the wax having an | |
| average particle size of 0.6 μm, produced by Gifu | |
| Shellac Co., Ltd.) to give a solid content of 5% by | |
| weight | |
| Trehalose (disaccharide) solution | 20 mg |
| (Treha, melting point of 97° C., produced by | |
| Hayashihara Shoji Co., Ltd., having a solid content | |
| of 10% by weight) | |
| Non-film formation polyester resin Vylonal PMD-1200, | 100 mg |
| water-dispersible non-film formation polyester resin, | |
| having a solid content of 41% by weight (produced by | |
| Toyo Boseki Co., Ltd.) | |
| Isoropanol | 80 mg |
| 2,4,7,9-tetramethyl-5-decyne-4,7-dipolyoxyethelene- | 5 mg |
| ether (SURFYNOL 465 produced by Air Products Japan, | |
| Inc.) | |
| Hydroxyether modified starch (PENON JE66 produced by | 15 mg |
| Nippon Starch Chemical Co., Ltd.) | |
| Infrared dye 1 | 5 mg |
| Aqueous solution of sodium polyacrylate AQUALIC DL522 | 45 mg |
| (water soluble resin with an average molecular weight | |
| of 170,000) produced by Nippon Shokubai Co., Ltd.) | |
| having a solid content of 30.5% | |

Infrared dye 1

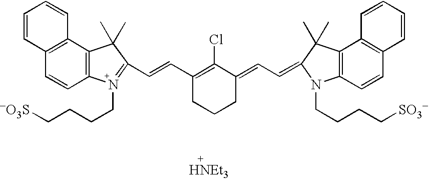

[Preparation of Outermost Backing Layer Coating Solution]

The materials as shown in Table 4 were sufficiently mixed in the amounts shown in Table 4 while stirring, employing a homogenizer, and filtered, diluted with pure water and dispersed to the outermost backing layer coating solution. In Table 4, numerical values represent solid content by weight per m².

TABLE 4

| | Weight |
|---|---|
| Materials | per m² |
| Colloidal silica (alkali type): Snowtex XS | 0.7 g |
| (solid 20% by weight, produced by Nissan | |
| Kagaku Co., Ltd.) | |
| Organic polymer matting agent made of | 0.06 g |
| polymethyl methacrylate resin (spherical | |
| form; average particle size of 5.5 μm) | |
| Silica matting agent (irregular form; average | — |
| particle size of 1.5 μm) | |
| Polyvinyl alcohol: PVA117 produced by | 0.01 g |
| Kuraray Co., Ltd. (10% by weight aqueous | |
| solution) | |
| Acryl emulsion AE986A (solid 35% by weight, | 0.6 g |
| produced by JSR Co., Ltd.) | |
| SURFYNOL 465 produced by Air Products Japan, | 0.01 g |
| Inc. (surfactant, adduct of acetylene diol | |
| with ethylene oxide) | |

<<Preparation of Printing Plate Material Sample>>

The resulting printing plate material was cut into a size of 73 cm (width)×32 m (length), and wound around a spool made of cardboard having a diameter of 7.5 cm. Thus, a printing plate material sample in roll form was prepared. The resulting printing material plate sample was wrapped in a 150 cm×2 m package made of A1203PET (12 μm)/Ny (15 μm)/CPP (70 μm). The resulting wrapped material was stored at 50° C. and 60% RH for seven days. The package had an oxygen permeation of 1.7×10⁻⁵ ml/Pa·m²·30° C.·day, and a moisture permeability of 1.8×10⁻⁵ g/Pa·m²·25° C.·day.

<<Evaluation of Printing Plate Material Sample>>

(a) Image Formation Employing Infrared Laser

The resulting printing plate material sample was imagewise exposed employing an infrared laser exposure device having a punch block for printing. Exposure was carried out employing infrared laser beams (having a wavelength of 808 nm and a laser beam spot diameter of 18 μm) at a resolution of 2400 dpi to form an image with a screen number of 175 lines. In the exposure, the exposure energy on the image formation layer surface was varied from 150 to 350 mJ/cm² at an interval of 50 mJ/cm². The term, “dpi” shows the number of dots per 2.54 cm. Thus, an exposed printing plate material sample was obtained.

Pinholes for printing were in advance produced in the resulting printing plate material sample.

<<Preparation of Dampening Solution>>

Dampening solutions E-1, E-2, E-3 and E-4 were prepared according to the composition as shown in Table 5 below. The dampening solutions E-1, E-2, E-3 and E-4 were adjusted to pH as shown in Table 5 with citric acid and/or sodium citrate, and used for printing. In Table 5, “%” represents % by weight, unless otherwise specified.

TABLE 5

| | Dampening solutions used | | | |
|---|---|---|---|---|
| Materials used | E-1 | E-2 | E-3 | E-4 |
| Propylene | 1% | 1% | 1% | 1% |
| glycol mono- | | | | |
| n-butyl ether | | | | |
| 1,2-Propane diol | 0.5% | 0.5% | 0.5% | 0.5% |
| 3,6-Dimethyl- | 0.5% | 0.5% | 0.5% | 0.5% |
| 4-octyne- | | | | |
| 3,6-diol | | | | |
| 1-Hydroxy- | 0.02* mol/l | — | — | — |
| ethylidene- | | | | |
| 1,1-diphosphonic | | | | |
| acid | | | | |
| Ethylenediamine- | — | 0.02 mol/l | — | — |
| tetramethylene- | | | | |
| phosphonic acid | | | | |
| Glycerin | 0.1% | 0.1% | 0.1% | 0.1% |
| Ammonium | 0.02% | 0.02% | 0.02% | 0.02% |
| nitrate | | | | |
| Carboxymethyl- | 0.01% | 0.01% | 0.01% | 0.01% |
| cellulose | | | | |
| Ammonium | 0.02 mol/l | 0.02 mol/l | — | 0.005% mol/l |
| dihydrogen- | | | | |
| phosphate | | | | |
| di-Ammonium | 0.01% | 0.01% | 0.01% | 0.01% |
| hydrogen | | | | |
| citrate | | | | |
| Sodium acetate | 0.01% | 0.01% | 0.01% | 0.01% |
| 2,3-Bromo-2- | 0.0002% | 0.0002% | 0.0002% | 0.0002% |
| nitroethanol | | | | |
| 2-Methyl- | 0.0002% | 0.0002% | 0.0002% | 0.0002% |
| 5-chloro-4- | | | | |
| isothiazoline-3-on | | | | |
| pH of dampening | 4.1 | 4.8 | 5.0 | 5.0 |
| solution used | | | | |

Water was added to make a 1 liter solution.
*mol/l represents mol/liter.

(c) Evaluation of Printing Plate Material Sample
<<Stain Elimination Property>>

The exposed printing plate material sample obtained above was mounted on a printing press DAIYA 1F-1 produced by Mitsubishi Jukogyo Co., Ltd., and then printing was carried out employing a coated paper, dampening solution as shown in Table 5, and printing ink SUPER TEK-PLUS magenta M produced by T & K TOKA CO., LTD.

Printing was carried out in the same manner as in the printing sequences as those carried out employing a conventional PS plate. After printing finished, the surface of the sample was observed and layers at the non-image portions in the printing plate material samples according to the invention were eliminated.

Successively, only printing ink was supplied to the surface of the sample was by the ink roller to form an ink layer on the entire surface of the sample, and then printing was restarted by supplying both printing ink and dampening solution to the formed ink layer. The number of prints printed from when printing restarted till when no ink stain was observed on non-image portions of the prints was counted and evaluated as a measure of stain elimination property. The less the number is, the better. The results of test carried out employing dampening solutions E-1 through E-3 are shown in Table 6 as Test Nos. 101 through 103.

<<Printing Durability>>

The exposed printing plate material sample obtained above was mounted on a printing press LITHRONE 26 produced by Komori Corporation, and then printing was carried out employing a coated paper, dampening solution E-1, E-2 or E-3 as shown in Table 6, and printing ink SUPER TEK-PLUS-SOYA Blue M produced by T & K TOKA CO., LTD., while spraying powder while spraying powder (Nikkalyco AS-160 M having an average particle size of 20-30 μm, produced by Nikka Ltd.) to obtain 50,000 prints. The number of prints printed from when printing started till when a 3% dot image lacked not less than 50% of the dots was counted, and evaluated as a measure of printing durability. The more the number is, the higher the printing durability. The results are shown in Table 6.

TABLE 6

| | | | Total | | Stain | |
|---|---|---|---|---|---|---|
| | | | content of | | elimi- | |
| | | | phosphorous | Printing | nation | |
| Test | Dampening | | compound | durability | property | Re- |
| Nos. | solution | pH | (mol/liter) | (number) | (number) | marks |
| 101 | E-1 | 4.1 | 0.04 | 100 | 2,000 | Comp. |
| 102 | E-2 | 4.8 | 0.04 | 100 | 2,000 | Comp. |
| 103 | E-3 | 5.0 | 0.00 | 15 | 20,000 | Inv. |

Comp.: Comparative,
Inv.: Inventive

### Example 2

A processless printing plate material sample having an aluminum support was prepared and imagewise exposed as described below. The resulting exposed sample was processed and evaluated in the same manner as in Example 1 above.

(Preparation of Aluminum Support)

A 0.24 mm thick aluminum plate (material 1050, refining H16) was degreased at 65° C. for one minute in a 5% sodium hydroxide solution, washed with water, immersed at 25° C. for one minute in a 10% hydrochloric acid solution to neutralize, and then washed with water.

The resulting aluminum plate was electrolytically surface-roughened at 25° C. for 30 seconds at a current density of 60 A/dm² in an aqueous 1.5% hydrochloric acid solution, and desmutted at 50° C. for 40 seconds in an aqueous 1% sodium hydroxide solution. The desmutted aluminum plate was anodized at 25° C. for 30 seconds at a current density of 30 A/dm² and at a voltage of 25 V in an aqueous 30% sulfuric acid solution, and subjected to sealing treatment at 85° C. for 120 seconds in an aqueous 0.1% ammonium acetate solution.

(Polyvinyl Phosphonic Acid Treatment)

The resulting anodized aluminum plate was immersed in a 0.44% polyvinyl phosphonic acid aqueous solution at 75° C. for 30 seconds, washed with pure water, and dried blowing cool air. Thus, aluminum support for a light sensitive planographic printing plate material sample was obtained.

The center line average surface roughness (Ra) of the support was 0.7 μm, measured by a magnification of 40 with a non-contact three-dimensional surface shape tester WYKO (produced by Veeco Co., Ltd.).

The number of concavities with an average size of from 30 to 150 nm on the roughened surface was 250/μm², measured a scanning electron microscope S-5000H (produced by HITACHI CO., LTD.) by a magnification of 100,000 under the following conditions.
Plate-Preferred: 1 nm coating
Acceleration voltage: 5 kV
Angle of inclination: zero degree
   <<Preparation of Printing Plate Material Sample>>

The following image formation layer coating solution and overcoat layer coating solution were coated on the resulting aluminum support with a coater, dried under drying condition described below to give a dry coating amount as shown below, and subjected to aging treatment as described below. Thus, a printing plate material sample was obtained. Image formation layer coating conditions:
Drying condition: 55° C. for 3 minutes;
Drying coating amount: 0.75 g/m²;
Overcoat layer coating conditions:
Drying condition: 55° C. for 3 minutes;
Drying coating amount: 0.30 g/m²;
Aging treatment: 40° C. for 24 hours

[Preparation of Image Formation Layer Coating Solution]

TABLE 7

| | Parts |
|---|---|
| | by |
| Materials | weight |
| Dispersion liquid prepared by diluting with pure | 5 |
| water carnauba wax emulsion A118 (having a solid | |
| content of 40% by weight, the wax having an average | |
| particle size of 0.25 μm, a melting viscosity at | |
| 140° C. of 8 cps, a softening point of 65° C., and a | |
| melting point of 80° C., produced by Gifu Shellac | |
| Co., Ltd.) to give a solid content of 5% by weight | |
| Non-film formation polyester resin Vylonal PMD- | 80 |
| 1200, water-dispersible non-film formation | |
| polyester resin, having a solid content of 41% by | |
| weight (produced by Toyo Boseki Co., Ltd.) | |
| Necklace colloidal silica (alkali type): Snowtex | 5 |
| PSW (solid 20% by weight, produced by Nissan Kagaku | |
| Co., Ltd.) | |
| Infrared dye 1 | 5 |
| Aqueous solution of sodium polyacrylate AQUALIC | 5 |
| DL522 (water soluble resin with an average | |
| molecular weight of 170,000) produced by Nippon | |
| Shokubai Co., Ltd.) having a solid content of 30.5% | |

[Preparation of Overcoat Layer Coating Solution]

Materials for the overcoat layer coating solution as shown in Table 8 were diluted with pure water and dispersed to obtain an overcoat formation layer coating solution.

TABLE 8

| | Parts |
|---|---|
| | by |
| Materials | weight |
| Aqueous solution of sodium polyacrylate AQUALIC | 15 |
| DL522 (water soluble resin with an average | |
| molecular weight of 170,000) produced by Nippon | |
| Shokubai Co., Ltd.) having a solid content of 30.5% | |
| Blocked isocyanate WB-700 | 40 |
| Trehalose (disaccharide) solution | 45 |
| (Treha, melting point of 97° C., produced by | |
| Hayashihara Shoji Co., Ltd., having a solid content | |
| of 10% by weight) | |
| Blue dye (Trade name: Blue No. 2 produced by Kiriya | 5 |
| Chemical Co., Ltd.) | |
| Matting. agent silica particles with an average | 5 |
| particle size of 10 μm | |

Blue dye

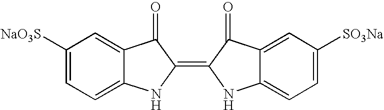

<<Image Formation Employing Infrared Laser>>

The resulting printing plate material sample was wound around an exposure drum, and imagewise exposed employing laser beams (having a wavelength of 830 nm and a laser beam spot diameter of 18 μm) at a resolution of 2400 dpi to form an image with a screen number of 175 lines including a solid image and a dot image with 1 to 99% dot area. In the exposure, the exposure energy on the image formation layer surface was 150 mJ/cm². The term, “dpi” shows the number of dots per 2.54 cm. Thus, an exposed printing plate material sample was obtained.

Pinholes for printing were in advance produced in the resulting printing plate material sample.

The resulting exposed printing plate material sample was processed employing dampening solutions E-1, E-2 and E-4 as shown in Table 5 in the same manner as in Example 1, and evaluated for elimination property and printing durability in the same manner as in Example 1.

The results are shown in Table 9.

TABLE 9

| | | | Total | | Stain | |
|---|---|---|---|---|---|---|
| | | | content of | | elimi- | |
| | | | phosphorous | Printing | nation | |
| Test | Dampening | | compound | durability | property | Re- |
| Nos. | solution | pH | (mol/liter) | (number) | (number) | marks |
| 201 | E-1 | 4.1 | 0.04 | 100 | 5,000 | Comp. |
| 202 | E-2 | 4.8 | 0.04 | 100 | 5,000 | Comp. |
| 203 | E-4 | 5.0 | 0.005 | 20 | 50,000 | Inv. |

Comp.: Comparative,
Inv.: Inventive

As is apparent from Table 9, the printing process according to the present invention provides excellent stain elimination property and high printing durability.

What is claimed is:

1. A printing process employing a processless printing plate material, the process comprising the steps of:
(a) imagewise exposing a printing plate material comprising a support with a hydrophilic surface and an image formation layer provided on the hydrophilic surface;
(b) mounting the exposed printing plate material on a plate cylinder of a printing press;
(c) supplying a dampening solution and printing ink to the mounted printing plate material, whereby the image formation layer at non-image portions is removed to obtain a printing plate; and
(d) further supplying the dampening solution and printing ink to the resulting printing plate, wherein the dampening solution contains water, a wetting property improvingagent, and a phosphorous compound in an amount of not more than 0.01 mol/liter, the dampening solution having a pH of from 4.5 to 8.0.

2. The printing process of claim 1, wherein the dampening solution contains no phosphorous compound.

3. The printing process of claim 1, wherein the dampening solution contains water in an amount of 90 to 99.8% by weight, and the wetting property improving agent in an amount of from 0.001 to 1% by weight.

4. The printing process of claim 1, wherein the image formation layer contains heat-melting particles or heat-fusible particles.

5. The printing process of claim 4, wherein a content of the heat-melting particles or heat-fusible particles in the image formation layer is from 0.1 to 95% by weight.

6. The printing process of claim 1, wherein the image formation layer has a thickness of from 0.1 to 10 μm.

7. The printing process of claim 1, wherein the support has on the surface a hydrophilic layer with a porous structure.

8. The printing process of claim 7, wherein the support comprises a plastic film and provided thereon, the hydrophilic layer.

9. The printing process of claim 8, wherein the plastic film is a polyethylene terephthalate film.

10. The printing process of claim 7, wherein the hydrophilic layer contains metal oxide particles with an average size of from 3 to 100 nm.

11. The printing process of claim 10, wherein the metal oxide particle content of the hydrophilic layer is from 0.1 to 95% by weight.

12. The printing process of claim 7, wherein the hydrophilic layer has a thickness of from 0.1 to 20 μm.

13. The printing process of claim 1, wherein the image formation layer contains a light-to-heat conversion material.

14. The printing process of claim 7, wherein the hydrophilic layer contains a light-to-heat conversion material.

15. The printing process of claim 7, wherein both image formation layer and hydrophilic layer contain a light-to-heat conversion material.

16. The printing process of claim 1, wherein a hydrophilic overcoat layer containing a water soluble resin or a water swellable resin is provided on the image formation layer.
